(19) United States
(12) Patent Application Publication
(10) Pub. No.: US 2026/0179339 A1
(43) Pub. Date: Jun. 25, 2026

(54) EXTENDED REALITY EXPERIENCES WITH SHARED HAND TRACKING

(71) Applicant: Snap Inc., Santa Monica, CA (US)

(72) Inventors: Georgios Evangelidis, Vienna (AT); Vsevolod Konjahhin, Vienna (AT); Matthew Penney, Vienna (AT); Dmytro Siryk, Vienna (AT); Ihor Tymchyshyn, Kyiv (UA); Kai Zhou, Wiener Neudorf (AT)

(21) Appl. No.: 19/049,746

(22) Filed: Feb. 10, 2025

(30) Foreign Application Priority Data
Dec. 23, 2024 (GR) 20240100931

(51) Int. Cl. G06T 19/20; G02B 27/01; G06F 3/01; G06T 7/20; G06T 7/70; G06V 40/20

(52) U.S. Cl. CPC G06T 19/20; G02B 27/017; G06F 3/014; G06T 7/20; G06T 7/70; G06V 40/28; G06T 2219/2004; G06V 2201/07

(57) ABSTRACT

Systems and methods in the present disclosure relate to the sharing of hand tracking data in the context of multi-user extended reality (XR) experiences. A first XR device of a first user and a second XR device of a second user participate in a shared XR experience. The first XR device receives, from the second XR device and via a communication link, hand tracking data for a second hand of the second user. The first XR device captures images that include a first hand of the first user and the second hand of the second user. While the shared XR experience is in progress, tracking operations performed by the first XR device are controlled based on the images captured by the first XR device and the hand tracking data it receives from the second XR device.

### CLAIM OF PRIORITY

This application claims the benefit of priority to Greece Patent Application Serial No. 20240100931, filed on Dec. 23, 2024, which is incorporated herein by reference in its entirety.

### TECHNICAL FIELD

The subject matter disclosed herein generally relates to extended reality (XR) technology. Particularly, but not exclusively, the subject matter relates to shared XR experiences that are generated for users operating connected XR devices.

### BACKGROUND

XR devices may enable colocated users to have a shared XR experience. Examples of shared experiences include a virtual tour in which attendees can see and interact with the same virtual content overlaying the real world, multiplayer gaming in which players can see and interact with the same virtual game elements overlaid on the real world, and a collaborative design project in which users gather in the same (real-world) room and use their XR devices to visualize and manipulate the same three-dimensional (3D) model of a design.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 diagrammatically illustrates a network environment for operating an XR device, according to some examples.

FIG. 2 is a block diagram illustrating components of an XR device, according to some examples.

FIG. 3 diagrammatically illustrates aspects of a shared XR experience involving a first user with a first XR device and a second user with a second XR device, according to some examples.

FIG. 4 diagrammatically illustrates a data sharing architecture in the context of a shared XR experience, according to some examples.

FIG. 5 illustrates a first user wearing a first XR device and a second user wearing a second XR device, where the first user and the second user interact with virtual content in the context of a shared XR experience, according to some examples.

FIG. 6 is a flowchart illustrating a method of facilitating a shared XR experience, according to some examples.

FIG. 7 illustrates, from the perspective of a first user, the first user interacting with a second user in the context of a shared XR experience, and further illustrates hand tracking data relative to hands of the first user and the second user, according to some examples.

FIG. 8 illustrates, from the perspective of the first user of FIG. 7, the first user interacting with the second user, and further illustrates hand tracking data relative to the hand of the first user, according to some examples.

FIG. 9 illustrates, from the perspective of the first user of FIG. 7, the first user interacting with the second user, and further illustrates hand tracking data relative to the hands of the first user and the second user, according to some examples.

FIG. 10 illustrates, from the perspective of the first user of FIG. 7, the first user interacting with the second user, and further illustrates hand tracking data relative to the hands of the first user and the second user, according to some examples.

FIG. 11 illustrates, from the perspective of the second user of FIG. 7, the second user interacting with the first user, and further illustrates hand tracking data relative to the hands of the first user and the second user, according to some examples.

FIG. 12 illustrates, from the perspective of the second user of FIG. 7, the second user interacting with the first user, and further illustrates hand tracking data relative to the hands of the first user and the second user, according to some examples.

FIG. 13 illustrates a network environment in which a head-wearable apparatus can be implemented, according to some examples.

FIG. 14 is a block diagram showing a software architecture within which the present disclosure may be implemented, according to some examples.

FIG. 15 is a diagrammatic representation of a machine in the form of a computer system within which a set of instructions may be executed for causing the machine to perform any one or more of the methodologies discussed herein, according to some examples.

### DETAILED DESCRIPTION

The term “augmented reality” (AR), as used herein, may include an interactive experience of a real-world environment where physical objects or environments that reside in the real world are “augmented,” modified, or enhanced by computer-generated digital content (also referred to as virtual content, synthetic content, or digital effects). AR may also refer to a system that enables a combination of real and virtual worlds, real-time interaction, and three-dimensional registration of virtual and real objects. In some examples, a user of an AR system can perceive virtual content that appears to be attached or interact with a real-world physical object. The term “AR application” is used herein to refer to a computer-operated application that enables an AR experience.

The term “virtual reality” (VR), as used herein, may include a simulation experience of a virtual world environment that is distinct from the real-world environment. Computer-generated digital content may thus be displayed in the virtual world environment. VR may refer to a system that enables a user of a VR system to be completely immersed in the virtual world environment and to interact with virtual objects presented in the virtual world environment.

XR devices may include AR devices and/or VR devices. While examples described in the present disclosure focus primarily on XR devices that provide an AR experience (e.g., virtual content overlaid onto the real world), it will be appreciated that at least some aspects of the present disclosure may also be applied in a VR context.

In some examples, XR devices enable colocated users (e.g., users who are physically present in the same room, hall, or park) to have a shared XR experience. A “shared XR experience,” as used herein, may include a synchronized multi-user session where two or more XR devices establish communication links to enable their users to interact with virtual content at the same time. The shared XR experience may include coordinated tracking and presentation of virtual content across multiple XR devices (e.g., multiple colocated XR devices), with each XR device typically executing a corresponding application that manages virtual content generation and facilitates alignment and synchronization with other participating XR devices.

These shared experiences or environments can be useful for various types of activities, such as gaming, education, entertainment, or design. For example, a shared XR experience may involve two users wearing head-mounted XR devices (e.g., AR glasses) that display the same virtual object (e.g., a planet or a ball) that can be passed between the users while maintaining consistent positioning and appearance for both users. In an AR context, this can be referred to as “colocated AR” or “collaborative AR,” as multiple users may collaborate in the same AR environment.

The term “common virtual content” or “shared virtual content,” as used herein, may include digital objects, effects, or other virtual elements that are simultaneously presented to multiple users participating in a shared XR experience with substantially consistent spatial positioning. For example, two users each wear AR glasses, and virtual content can be presented to them via their AR glasses so as to appear in substantially the same place relative to the real world (e.g., a physical object such as the hand of one of the users). In some examples, the common virtual content maintains synchronized appearance and behavior across different users' views through alignment operations and pose corrections based on shared tracking data. For example, when one user passes a virtual object to another user as part of an XR experience, both users see the same object with substantially consistent size, position, and orientation as it moves between their hands, even as the users move and interact with it.

To create a shared environment that is spatially and temporally consistent for multiple users, an initialization process can involve aligning the perspectives of the users. An XR device may have a pose tracker, often referred to as an “ego-pose tracker,” that identifies and tracks the position (e.g., 3D location) and typically also orientation (e.g., 3D rotation) of the XR device itself within an environment. This allows, for instance, the XR device to understand where it is in the real world and how it is oriented. Local coordinate systems can be spatially and temporally aligned. For example, XR devices can either be localized against each other (e.g., by ego-motion alignment) or relative to a common (e.g., global) map. Spatial alignment allows the XR devices to agree on where objects are located in space. Temporal alignment means that the XR devices should agree on when events are occurring. This can be achieved, for example, by ensuring that XR device clocks are substantially synchronized and causing presentation of particularly positioned and oriented common virtual content at substantially the same time.

Rapid and accurate tracking can enable an XR device to provide more realistic, entertaining, immersive, or useful XR experiences, including shared XR experiences. For example, effective object tracking can allow a first XR device and a second XR device to present common virtual content to their respective users in such a way that the virtual content appears in the same real-world area or overlaid onto the same real-world objects from the perspective of both users.

In various XR devices, and particularly in head-worn AR devices, the hands of the user serve as an interaction tool (e.g., a primary tool for interacting with the XR device and/or virtual content). For example, the XR device generates and presents a gesture-driven user interface to the user, and the user performs predetermined hand gestures, such as swiping, tapping, pinching, and dragging, to interact with virtual content (e.g., objects and data items) via the gesture-driven user interface. Hands can also be used in shared XR experiences, for instance, to manipulate common virtual objects, to provide user input, or to trigger actions. To this end, the XR device may be configured to implement a hand tracker (e.g., as part of an object tracking system) that can detect and track the hands.

Examples in the present disclosure provide systems and methods for the sharing of hand tracking data and the use of shared hand tracking data across multiple (e.g., two or more) XR devices. The term “hand tracking data,” as used herein, may include information describing one or more of the position, motion, orientation, or characteristics of a hand (or parts thereof), or multiple hands, as detected and tracked by an XR device (e.g., by a hand tracker of an XR device). The hand tracking data can include, for example, hand pose data, hand landmark data indicating joint positions, hand motion data, or hand identification information associating hands with specific users. For example, hand tracking data can include a set of tracked hand landmarks for a particular hand, along with an identifier indicating which user the hand belongs to (e.g., another user participating in the shared experience).

For example, a first XR device of a first user tracks a first hand of the first user, and a second XR device of a second user tracks a second hand of the second user. The second XR device transmits its hand tracking data for the second hand to the first XR device, thereby enabling the first XR device to have a priori knowledge of where the second hand is located. In some examples, by sharing hand tracking data from one XR device to another XR device, the other XR device is provided with additional information (e.g., a second “source of truth”) that can be processed to improve the shared XR experience.

It is noted that any capturing, generation, and/or sharing of hand tracking data as described herein is performed only if prior user approval is provided for such operations. Furthermore, the data is used for limited purposes such as those described herein and only during the relevant session(s).

An example method may include receiving, by a first XR device that is connected to a second XR device, hand tracking data for a hand of a user of the second XR device. The first XR device then controls one or more tracking operations based on the hand tracking data received from the second XR device. The first XR device may similarly share hand tracking data for a hand of its user with the second XR device.

In some examples, the first XR device and the second XR device communicate tracking data at a tracker level (e.g., as opposed to, or in addition to, sharing tracking data at a shared experience application level). For example, each XR device executes its own hand tracker based on images captured by one or more cameras of that XR device (and/or using other sensors, such as depth sensors) to generate hand tracking data, and the hand trackers communicate with each other to share the hand tracking data. In addition, the XR devices may share other data, such as device pose data (e.g., Visual-Inertial Odometry (VIO) poses or Simultaneous Localization and Mapping (SLAM) poses of the respective XR devices) to facilitate a shared XR experience.

Examples in the present disclose provide one or more technical solutions to technical problems. One example of a technical problem is pose drift and misalignment in the context of a shared XR experience. In a multi-user XR system, the relative poses between XR devices can drift over time. This can, for example, occur due to limitations in VIO or SLAM tracking. Drift may cause virtual content to appear misaligned between different users' views, as described in examples included in the present disclosure, degrading the quality of the XR experience.

Subject matter in the present disclosure enables real-time and direct hand tracking communication between XR devices to address or alleviate pose drift and misalignment. For example, by having access to both its own hand tracking data and the hand tracking data received from another XR device, an XR device can detect or estimate misalignment and adjust the estimated (relative) pose between the XR devices. This, in turn, allows the XR device to correct or compensate for drift locally to maintain more accurate alignment of virtual content, for example, relative to users' hands.

In some examples, an XR device receives information from another XR device that identifies another user's hand. When the XR device captures that other user's hand in its own field of view, it can “deliberately” track the other user's hand, knowing which hand it is, based on the information received from the other XR device (even though it is not the hand of its own user). As a result, the XR device possesses both its own tracking data for the hand and the tracking data received from the other XR device, thereby enabling it to analyze the two sets of data, and estimate and correct for drift. This may facilitate a better (e.g., more accurate, realistic, or immersive) XR experience.

Another example of a technical problem is hand identity confusion or uncertainty. If an XR device detects and starts tracking a non-user hand (e.g., a hand that is in its field of view but does not belong to its user), it can result in technical challenges in certain contexts. The tracking of non-user hands in addition to user hands increases the computational burden on the XR device, resulting, for example, in poor battery life or latency issues. Furthermore, mistaking a non-user hand for a user hand can lead to the XR device incorrectly detecting non-user hand gestures as inputs or control instructions. In other words, the XR device may erroneously track another person's hand as that of its operator.

Subject matter in the present disclosure enables an XR device to more reliably distinguish between different users' hands when they interact in close proximity, thereby addressing or alleviating the technical problem of hand identity confusion or uncertainty. In some examples, connected XR devices share hand tracking data such as hand pose data, hand landmark data, and/or hand identification information. When an XR device detects a hand in captured images, it can use the received tracking data to identify (or more reliably estimate) whether the hand belongs to another user participating in a shared XR experience. This may prevent the XR device from incorrectly identifying another user's hand as belonging to its own user, enabling proper hand tracking during close interactions between users. As mentioned above, this can also help the XR device to “deliberately” track the other hand where it is appropriate to do so, knowing that it is a non-user hand (e.g., to aid in drift correction), while also being able to “deliberately” exclude such a hand from tracking where relevant.

Furthermore, hand tracking data sharing as described herein may enable an XR device to more easily or reliably detect the presence of a hand that belongs to a person who is not participating in a shared XR experience. For example, based on data sharing with a second XR device participating in the shared XR experience, a first XR device is aware of the hands that are relevant in the context of the shared XR experience. Upon detecting a further hand in its field of view, the first XR device may then more easily identify that the further hand belongs to a non-participant (e.g., a person who is not operating a connected device that is sharing hand tracking data), and simply exclude that hand from hand tracking. This may facilitate a better (e.g., more efficient, seamless, or realistic) XR experience that avoids or reduces hand identity confusion or uncertainty.

Another example of a technical problem is inefficient hand data processing. In some examples, an XR device may attempt to track one or multiple hands appearing in its field of view, even when such hands need not be tracked for purposes of providing the relevant XR experience. For example, while a shared XR experience is in progress, each XR device independently tries to detect and track all visible hands without knowing which hands belong to which users, with the field of view potentially even including hands of non-participants. This can lead to additional computational overhead as trackers continuously search for additional hands and attempt to generate tracking data for those hands upon detection.

Examples in the present disclosure allow for establishment of communication between hand trackers executing on different XR devices to share hand tracking data. As mentioned, when detecting hands in captured images, an XR device can identify (or more reliably estimate) which hands belong to which users based on the shared tracking data. This allows the device to selectively exclude hands of other users from its tracking operations and/or more easily identify non-participants, avoiding additional processing and power consumption that would, for instance, occur from attempting to track all visible hands in an indiscriminate manner. As a result, examples in the present disclosure can provide for lower-power hand tracking in multi-user XR contexts.

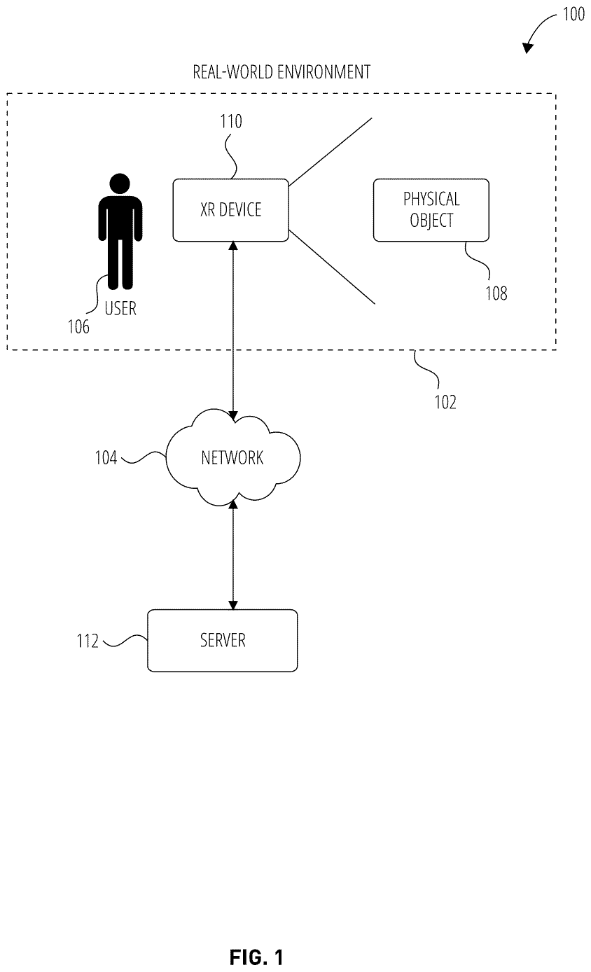

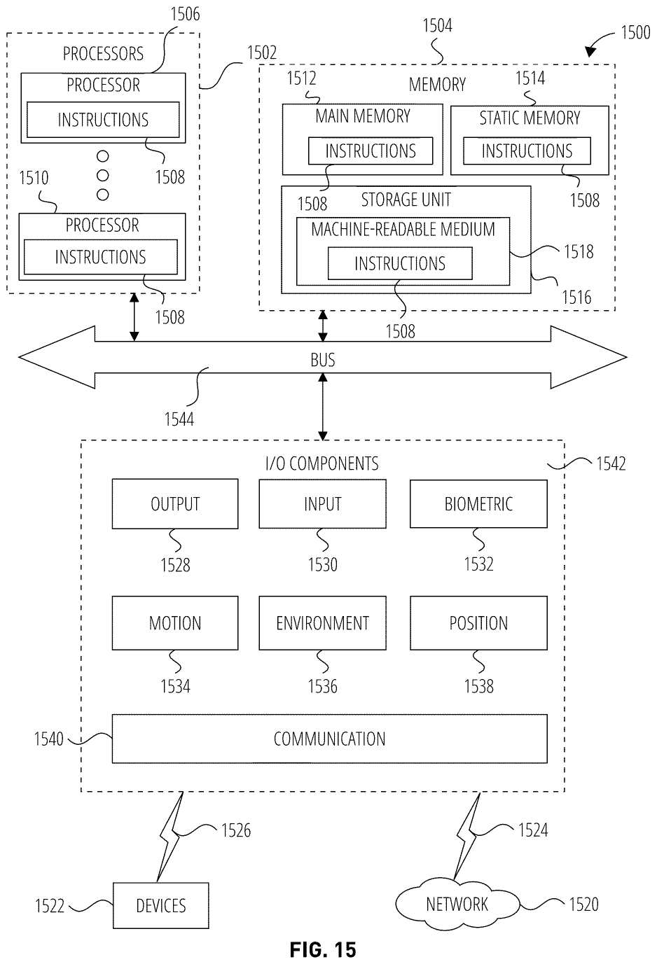

FIG. 1 is a network diagram illustrating a network environment 100 suitable for operating an XR device 110, according to some examples. The network environment 100 includes an XR device 110 and a server 112, communicatively coupled to each other via a network 104. The XR device 110 and the server 112 may each be implemented in a computer system, in whole or in part, as described below with respect to FIG. 15. The server 112 may be part of a network-based system. For example, the network-based system may be or include a cloud-based server system that provides additional information, such as virtual content (e.g., three-dimensional models of virtual objects, or digital effects to be applied, for example, as virtual overlays onto images depicting real-world scenes) to the XR device 110.

A user 106 operates the XR device 110. In some examples, the user 106 can be a human user (e.g., a human being), a machine user (e.g., a computer configured by a software program to interact with the XR device 110), or a combination thereof (e.g., a human assisted by a machine or a machine supervised by a human).

The user 106 is not part of the network environment 100, but is associated with the XR device 110. For example, where the XR device 110 is a head-wearable apparatus (e.g., AR glasses or an AR headset), the user 106 wears the XR device 110 during a user session.

The XR device 110 may have different display arrangements. In some examples, the display arrangement may include a screen that displays what is captured with a camera of the XR device 110. In other examples, the display of the device may be transparent or semi-transparent. In other examples, the display may be non-transparent and wearable by the user to cover the field of vision of the user.

In some examples the user 106 operates an application of the XR device 110, referred to herein as an AR application. The AR application may be configured to provide the user 106 with an experience triggered or enhanced by a physical object 108, such as a two-dimensional physical object (e.g., a picture), a three-dimensional physical object (e.g., a statue, a hand of the user, or the hand of another person), a location (e.g., a factory or shop), or any references (e.g., perceived corners of walls or furniture, or Quick Response (QR) codes) in the real-world physical environment. For example, the user 106 may point a camera of the XR device 110 to capture an image of the physical object 108 and a virtual overlay may be presented over the physical object 108 via the display. Experiences may be triggered or enhanced by a hand or other body part of the user 106 or of another person, e.g., the XR device 110 may detect and respond to hand gestures.

The XR device 110 includes tracking components (not shown in FIG. 1). The tracking components track the pose (e.g., position and/or orientation) of the XR device 110 relative to the real-world environment 102 using image sensors (e.g., depth-enabled 3D camera, and image camera), inertial sensors (e.g., gyroscope, accelerometer, or the like), wireless sensors (e.g., Bluetooth™ or Wi-Fi™), a Global Positioning System (GPS) sensor, and/or audio sensor to determine the location of the XR device 110 within the real-world environment 102.

In some examples, the server 112 may be used to detect and identify the physical object 108 based on sensor data (e.g., image and depth data) from the XR device 110, and determine a pose of the XR device 110 and the physical object 108 based on the sensor data. The server 112 can also generate a virtual object based on the pose of the XR device 110 and the physical object 108.

In some examples, the server 112 communicates a virtual object to the XR device 110. The XR device 110 or the server 112, or both, can also perform image processing, object detection and object tracking functions based on images captured by the XR device 110 and one or more parameters internal or external to the XR device 110. The object recognition, tracking, and AR rendering can be performed on either the XR device 110, the server 112, or a combination between the XR device 110 and the server 112. Accordingly, while certain functions are described herein as being performed by either an XR device or a server, the location of certain functionality may be a design choice. For example, a particular technology and functionality may be deployed within a server system initially, but later to migrate this technology and functionality to a client installed locally at the XR device where the XR device has sufficient processing capacity.

The network 104 may be any network that enables communication between or among machines (e.g., server 112), databases, and devices (e.g., XR device 110). Accordingly, the network 104 may be a wired network, a wireless network (e.g., a mobile or cellular network), or any suitable combination thereof. The network 104 may include one or more portions that constitute a private network, a public network (e.g., the Internet), or any suitable combination thereof.

The server 112 and/or XR device 110 can also implement a compliance system to facilitate compliance with data privacy and other regulations, including for example the California Consumer Privacy Act (CCPA), General Data Protection Regulation (GDPR), and Digital Services Act (DSA). The compliance system comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system also incorporates opt-in/opt-out management and privacy controls across the digital interaction system, empowering users to manage their data preferences. The compliance system is designed to handle sensitive data by obtaining explicit consent, implementing strict access controls and in accordance with applicable laws.

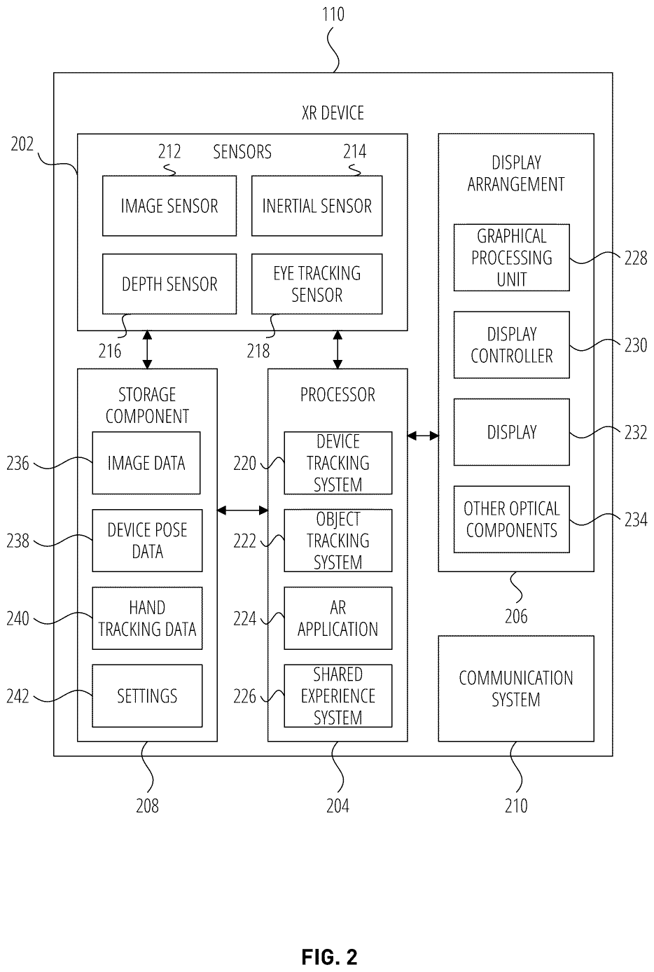

FIG. 2 is a block diagram illustrating components (e.g., parts, modules, arrangements, systems, or subsystems) of the XR device 110, according to some examples. The XR device 110 is shown to include sensors 202, a processor 204, a display arrangement 206, a storage component 208, and a communication system 210. It will be appreciated that FIG. 2 is not intended to provide an exhaustive indication of components of the XR device 110.

The sensors 202 include at least one image sensor 212, at least one inertial sensor 214, at least one depth sensor 216, and at least one eye tracking sensor 218. The image sensor 212 may include, for example, a combination of a color camera, a thermal camera, a depth sensor, and one or multiple grayscale, global shutter tracking cameras.

The inertial sensor 214 may include a combination of a gyroscope, accelerometer, and a magnetometer. In some examples, the inertial sensor 214 includes one or more Inertial Measurement Unit (IMU). An IMU enables tracking of movement of a body by integrating the acceleration and the angular velocity measured by the IMU. The term “IMU” can refer to a combination of accelerometers and gyroscopes that can determine and quantify linear acceleration and angular velocity, respectively. The values obtained from the gyroscopes of the IMU can be processed to obtain the pitch, roll, and heading of the IMU and, therefore, of the body with which the IMU is associated. Signals from the accelerometers of the IMU also can be processed to obtain velocity and displacement.

The depth sensor 216 may include a combination of a structured-light sensor, a time-of-flight sensor, passive stereo sensor, and an ultrasound device. The eye tracking sensor 218 is configured to monitor the gaze direction of the user, providing data for various applications, such as data for determining where (from the perspective of the user) to position virtual user interface elements or other virtual objects. The XR device 110 may include one or multiple of these sensors, e.g., infrared eye tracking sensors, corneal reflection tracking sensors, or video-based eye-tracking sensors.

Other examples of sensors 202 that can be incorporated into the XR device 110 include a proximity or location sensor (e.g., near field communication, Global Positioning System (GPS), Bluetooth™, or Wi-Fi™), an audio sensor (e.g., a microphone), or any suitable combination thereof. It is noted that the sensors 202 described herein are for illustration purposes and the sensors 202 are thus not necessarily limited to the ones described above.

The processor 204 operates to implement a device tracking system 220, an object tracking system 222, an AR application 224, and a shared experience system 226.

The device tracking system 220 estimates a pose of the XR device 110. For example, the device tracking system 220 uses data from the image sensor 212 and the inertial sensor 214 to track a location and pose of the XR device 110 relative to a frame of reference (e.g., real-world environment 102). In some examples, the device tracking system 220 uses the image data 236 to determine the pose of the XR device 110. The pose may include a determined orientation and position of the XR device 110 in relation to the user's real-world environment 102.

In some examples, the device tracking system 220 continually gathers and uses updated sensor data describing movements of the XR device 110 to determine updated poses of the XR device 110 that indicate changes in the relative position and/or orientation of the XR device 110 from the physical objects in the real-world environment 102. The device tracking system 220 provides the pose of the XR device 110 to other components, such as the AR application 224, the shared experience system 226, or a graphical processing unit 228 of the display arrangement 206.

A SLAM system may be used to understand and map a physical environment in real-time. This allows, for example, an XR device to accurately place digital objects in the real world and track their position as a user moves and/or as objects move. The XR device 110 may include a VIO system that combines data from an IMU and a camera to estimate the position and orientation of an object in real-time. In some examples, a VIO system may form part of a SLAM system. A VIO system typically uses computer vision algorithms to analyze camera images and estimate the movement and position of the XR device 110, while also using IMU data to improve the accuracy and reliability of the estimates. By combining visual and inertial data, VIO may provide robust and accurate tracking.

The object tracking system 222 enables the tracking of an object, such as the physical object 108 or a hand of a person. The object tracking system 222 may include a computer-operated application or system that enables a device or system to track visual features identified in images captured by one or more image sensors, such as one or more cameras. In some examples, the object tracking system builds a model of a real-world environment based on the tracked visual features. An object tracking system may implement one or more object tracking machine learning models to track an object in the field of view of a user during a user session. The object tracking machine learning model may comprise a neural network trained on suitable training data to identify and track objects in a sequence of frames captured by the XR device 110. It typically uses an object's appearance, motion, landmarks, and/or other features to estimate location in subsequent frames.

In some examples, the object tracking system 222 implements a hand tracker of the XR device 110 that is specifically configured for human hand tracking. A hand tracker may include computer vision software that detects, identifies, and tracks hand positions and movements using input from one or multiple sensors. In some examples, the hand tracker processes image data from image sensors and depth sensors to detect hand landmarks representing joint positions and skeletal structure. The software implements computer vision algorithms to identify hands in captured images, track their motion over time, and determine hand poses. The hand tracker may utilize machine learning models or rules-based systems to distinguish between different users' hands and reject hands of irrelevant persons.

An XR device can be configured so as to perform egocentric hand tracking. In this context, “egocentric hand tracking” refers to hand tracking that is performed from a first-person perspective, with the “first person” being the user 106 of the XR device 110. For example, the user wears the XR device 110 on (or it is otherwise mounted on) their head, shoulder, or chest, capturing a scene substantially as the user 106 would see it. The XR device 110 thus tracks the position, orientation, or movement of the hand of the user 106 substantially from the viewpoint of the user. In addition to egocentric hand tracking, in some examples, and as further described elsewhere in the present disclosure, the XR device 110 can also track other hands, such as the hand of another user who is participating with the user 106 in a shared XR experience.

The AR application 224 may retrieve a virtual object (e.g., 3D object model) based on an identified physical object 108 or physical environment (or other real-world feature), or retrieve a digital effect to apply to the physical object 108. The graphical processing unit 228 causes display of the virtual object, digital effect, or the like. In some examples, the AR application 224 includes a local rendering engine that generates a visualization of a virtual object overlaid (e.g., superimposed upon, or otherwise displayed in tandem with) on an image of the physical object 108 (or other real-world feature) captured by the image sensor 212. A visualization of the virtual object may be manipulated by adjusting a position of the physical object or feature (e.g., its physical location, orientation, or both) relative to the image sensor 212. Similarly, the visualization of the virtual object may be manipulated by adjusting a pose of the XR device 110 relative to the physical object or feature.

The shared experience system 226 can perform various functions related to shared XR experiences. In some examples, shared experience system 226 enables the XR device 110 to establish a shared coordinate system with another XR device, such as by aligning with a global reference system. Establishing a shared coordinate system may involve one or both of spatial alignment and temporal alignment. The shared experience system 226 may utilize image-based techniques to perform or facilitate ego-motion alignment. In some examples, the shared experience system 226 uses common marker capturing to allow XR devices to align by capturing real-world markers.

Once the XR device 110 and one or more other XR devices have established a shared coordinate system and their clocks have been appropriately synchronized, the shared experience system 226, together with the AR application 224, may ensure that virtual content is presented to the user 106 in the correct positions and at the correct time. For example, while a shared experience is in progress during a user session, the shared experience system 226 may communicate with the device tracking system 220 and the object tracking system 222, and also with the other XR device via the communication system 210 of the XR device 110, to provide the AR application 224 with positional and/or temporal information to allow the AR application 224 to render, position, and time the presentation of virtual content.

In some examples, the shared experience system 226 determines an alignment transformation to transform a local pose of the XR device 110, based on its own ego-pose tracker, to a pose expressed in a global or shared coordinate system. The shared experience system 226 may also determine a time offset between the XR device 110 and another XR device such that the AR application 224 can synchronize the presentation of virtual content with corresponding presentation by the other XR device. For example, the clocks of two XR devices can be synchronized such that, if a user of one of the XR devices moves a virtual object during a shared experience, the user of the other XR device sees this movement at the same time, thereby ensuring a seamless shared experience.

Clock synchronization may involve all relevant devices agreeing on a common timestamp reference. The reference may be a global reference time that is separate from the clocks of the XR devices, or the XR devices may agree to synchronize by adjusting to the clock of one of the XR devices. Clock synchronization can be performed through synchronization with an external source. Network Time Protocol (NTP) is commonly used for such external synchronization. NTP is designed to synchronize the clocks of devices over a network. NTP uses a hierarchical, client-server architecture. At the top of the hierarchy, there are reference clocks or time servers, which provide accurate time signals. Servers lower down in the hierarchy then receive these time signals and distribute them to clients still further down in the hierarchy. When an NTP client wants to synchronize its clock, it sends a request to an NTP server, which responds with timestamp information enabling the client to adjust its clock.

Referring to the display arrangement 206, the display arrangement 206 can include a display controller 230 and a display 232. In some examples, the display arrangement 206 includes multiple displays. The display 232 may include a screen or panel configured to display images generated by the processor 204 or the graphical processing unit 228. In some examples, the display 232 may be transparent or semi-transparent so that the user 106 can see through the display 232.

In some examples, the display 232 may be offset from the gaze path of the user and other optical components 234 may direct light from the display 232 into the gaze path. The other optical components 234 may include, for example, one or more mirrors, one or more lenses, and one or more beam splitters.

Referring again to the graphical processing unit 228, the graphical processing unit 228 may include a render engine that is configured to render a frame of a 3D model of a virtual object based on the virtual content provided by the AR application 224 and the pose of the XR device 110 (and, in some cases, the position of a tracked object). In other words, the graphical processing unit 228 may use the pose of the XR device 110 to generate frames of virtual content to be presented on the display 232. For example, the graphical processing unit 228 uses the three-pose to render a frame of the virtual content such that the virtual content is presented at an orientation and position in the display 232 to properly augment the user's reality. As an example, the graphical processing unit 228 may use the pose data to render a frame of virtual content such that, when presented on the display 232, the virtual content is caused to be presented to a user so as to overlap with a physical object in the user's real-world environment 102. The graphical processing unit 228 can generate updated frames of virtual content based on updated three-dimensional poses of the XR device 110 and updated tracking data generated by the abovementioned tracking components, which reflect changes in the position and orientation of the user in relation to physical objects in the user's real-world environment 102, thereby resulting in a more immersive experience.

In some examples, the graphical processing unit 228 transfers the rendered frame to the display controller 230. The display controller 230 is positioned as an intermediary between the graphical processing unit 228 and the display 232, receives the image data (e.g., rendered frame) from the graphical processing unit 228, re-projects the frame (e.g., by performing a warping process) based on a latest pose of the XR device 110 (and, in some cases, object tracking pose forecasts or predictions), and provides the re-projected frame to the display 232.

It will be appreciated that, in examples where an XR device includes multiple displays, each display may have a dedicated graphical processing unit and/or display controller. It will further be appreciated that where an XR device includes multiple displays, such as in the case of AR glasses or any other AR device that provides binocular vision to mimic the way humans naturally perceive the world, a left eye display arrangement and a right eye display arrangement may deliver separate images or video streams to each eye.

Where an XR device includes multiple displays, steps may be carried out separately and substantially in parallel for each display, in some examples, and pairs of features or components may be included to cater for both eyes. For example, an XR device may capture separate images for a left eye display and a right eye display (or for a set of right eye displays and a set of left eye displays), and render separate outputs for each eye to create a more immersive experience and to adjust the focus and convergence of the overall view of a user for a more natural, three-dimensional view. Thus, while a single set of display arrangement components may be discussed to describe some examples, similar techniques may be applied to cover both eyes by providing a further set of display arrangement components.

The storage component 208 may store various types or forms of data, such as image data 236, device pose data 238, hand tracking data 240, and settings 242, as shown in FIG. 2. The image data 236 may include visual information captured by the image sensor 212 of the XR device that is and used for hand detection and tracking. The image data may comprise frames showing user hands and other objects in the field of view that can be processed to identify and track hand positions and movements during shared XR experiences. The device pose data 238 may include information describing the position and orientation of the XR device 110 (e.g., SLAM or VIO poses), or of XR devices relative to each other or the environment during a shared XR experience. The device pose data enables spatial alignment between devices and may be continuously updated to maintain synchronized views of common virtual content, with pose corrections applied based on hand tracking data to compensate for drift, as described in the present disclosure. The device pose data may include pose data generated by the XR device 110 itself and device pose data shared with the XR device 110 by other XR devices.

The hand tracking data 240 may include hand tracking data. In some examples, the hand tracking data 240 includes both hand tracking data generated by the hand tracker of the XR device 110 itself, and further hand tracking data received by the XR device 110 from another XR device (e.g., as generated by the other device's hand tracker). The settings 242 may include configuration parameters that control how the XR device performs various functions, such as hand tracking, pose estimation, relative pose adjustments, virtual content position, or virtual content presentation during shared XR experiences. The settings may specify tracking rates, alignment parameters, and other options that determine how data (e.g., tracking data) is processed and shared between devices.

The communication system 210 is configured to enable the XR device 110 to communicate with other XR devices and/or with other systems, such as remote servers. In some examples, the communication system 210 allows the XR device 110 to connect and share data with colocated devices. For example, the XR device 110 can connect with another XR device to share SLAM poses and hand tracking data.

The communication system 210 can utilize one or more wireless communication protocols, specialized APIs, and/or cloud-based services. For example, the communication system 210 is used to establish a local peer-to-peer connection or uses a central cloud server to facilitate the exchange of data. In each case, the communication system 210 enables a communication link between the two devices.

Local connections may use protocols such as Wi-Fi Direct, Bluetooth Low Energy (BLE), or ultra-wideband (UWB) for discovery or proximity-based communication, enabling the devices to share data in real time with minimal latency. Some devices may also utilize protocols such as 5G for high-bandwidth, low-latency connections, such as in scenarios requiring extended spatial maps or larger datasets.

To share pose data, an XR platform can employ standardized or proprietary protocols to encode, transmit, and synchronize data. For example, the XR device 110 can use optimized data structures to share positional and environmental mapping information. Data can be shared using low-latency peer-to-peer communication for data streaming, including in shared XR experience scenarios. The connected devices can rely on timestamping, spatial anchors, and quaternion-based orientation data to ensure accurate synchronization across participants. End-to-end encryption can be employed to protect data during transmission, ensuring privacy and security for users in collaborative or shared environments.

Referring again to the hand tracking data 240, in some examples, the communication system 210 facilitates bidirectional sharing of the hand tracking data 240 between XR devices. The hand tracking data 240 can include various types of tracking information that is shared between XR devices during a shared XR experience.

The hand tracking data 240 may include skeletal tracking information representing the positions and orientations of hand joints and landmarks. This data can represent joints of the hand through a set of interconnected points that indicate the skeletal structure. The object tracking system 222 can generate, or the communication system 210 can share, this data at variable update rates, such as 30 Hz or 10 Hz, depending on application requirements.

The hand tracking data 240 may include identification metadata that associates tracked hands with specific users or devices. This may include user identifiers, device identifiers, or information about whether a tracked hand is a left or right hand. The identification data may enable devices to properly attribute tracked hands to their respective users during multi-user interactions.

For spatial reference, the hand tracking data 240 may include coordinate transformation information that enables mapping between different devices' coordinate systems. This can be represented in either local device coordinates or a shared global reference frame, allowing devices to properly align and interpret hand positions relative to each other.

In some examples, the processor 204 includes simpler or more general representations such as bounding boxes or masks that indicate the general area where a hand is located. These representations can be used for initial hand detection or filtering operations without requiring full skeletal tracking data.

The data format in which the hand tracking data 240 is shared can be designed to be compact and efficient. For example, for a particular hand, a set of data can include around 100 floating point values that describe the pose of the hand. As another example, a set of data may include more limited information, such as a simplified indication of an area or zone in which the hand is located together with an identifier of the corresponding user or device. This may facilitate continuous, rapid, or real-time sharing between devices while maintaining low bandwidth requirements. The update frequency and level of detail can be adjusted through device settings to optimize performance and power consumption based on specific use cases.

One or more of the components described herein may be implemented using hardware (e.g., a processor of a machine) or a combination of hardware and software. For example, a component described herein may configure a processor to perform the operations described herein for that module. Moreover, two or more components may be combined into a single component, and the functions described herein for a single component may be subdivided among multiple components. Furthermore, according to various examples, components described herein as being implemented within a single machine, database, or device may be distributed across multiple machines, databases, or devices.

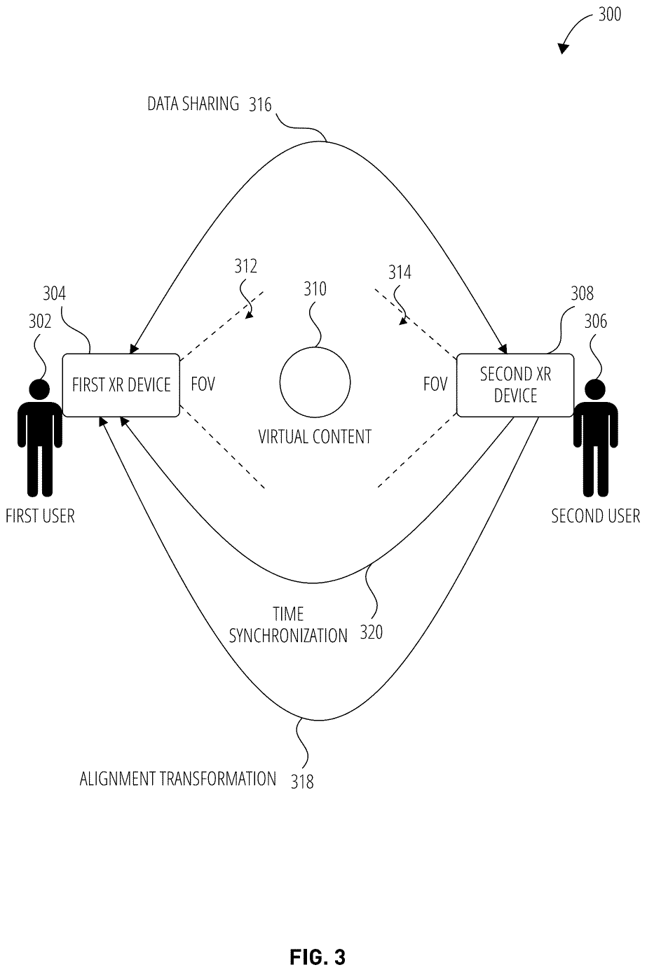

FIG. 3 diagrammatically illustrates aspects of shared XR experience 300 involving a first user 302 with a first XR device 304 and a second user 306 with a second XR device 308, according to some examples. The first XR device 304 and/or the second XR device 308 may include one or more components similar to those of the XR device 110 as described with reference to FIG. 1 and FIG. 2. Accordingly, to describe certain aspects, reference is made below to components of the XR device 110. Where the first XR device 304 and the second XR device 308 are head-wearable devices, the first user 302 is a wearer of the first XR device 304 and the second user 306 is a wearer of the second XR device 308 during the shared XR experience 300.

The shared XR experience 300 of FIG. 3 is a shared AR experience in which virtual content 310 is presented in a field of view 312 of the first XR device 304 and in a field of view 314 of the second XR device 308 at the same time. The virtual content 310 can be overlaid onto real-world objects in the real-world environment, e.g., a room or a park, in which the first user 302 and the second user 306 are located.

The first user 302 and the second user 306 may be able to interact with the virtual content 310, e.g., through hand movements. The first XR device 304 and the second XR device 308 can track the hands of the users to facilitate the shared XR experience 300. For example, the first user 302 and the second user 306 may be standing at opposite sides of a table and manipulate a virtual object that is presented to appear on a top surface of the table (with the first user 302 and the second user 306 viewing the virtual object from opposite sides). The virtual content 310 can thus be referred to as common virtual content or shared virtual content.

In FIG. 3, the first XR device 304 and the second XR device 308 are communicatively coupled to each other to enable data sharing 316. For example, the first XR device 304 may use the communication system 210 to establish a wireless link with the second XR device 308 for data sharing. The first XR device 304 can, in some examples, access poses (e.g., 6 degrees-of-freedom, or 6DOF, poses) of the second XR device 308 via the wireless link to track a pose trajectory of the second XR device 308 while the second user 306 is moving (relative to the first XR device 304). Likewise, the first XR device 304 can share its pose with the second XR device 308 while the shared XR experience 300 is in progress.

As mentioned, spatial and temporal alignment may be performed to ensure a seamless or collaborative AR experience. The first XR device 304 may perform alignment, which may involve determining an alignment transformation 318 to align a local coordinate system of the first XR device 304 with a local coordinate system of the second XR device 308, as shown in FIG. 3. FIG. 3 further shows that time synchronization 320 may be performed. The first XR device 304 and the second XR device 308 may use the shared experience system 226 for alignment and synchronization operations.

In some examples, AR experiences are designed to operate in devices that have their poses expressed in the same coordinate system and time-stamped from the same (or an aligned) clock. Ego-motion alignment can be performed to align the local coordinate systems and establish a shared coordinate system. When performing ego-motion alignment, one XR device may be a “host” with one or more “clients” connecting to the host. For example, the first XR device 304 may be the host, with the first XR device 304 determining a transformation to align the local coordinate system of the second XR device 308 with that of the first XR device 304.

When performing ego-motion alignment, different techniques can be used to determine the alignment transformation 318. For example, each XR device receives the pose of the other XR device and also captures images of the other user. The shared pose trajectory of the other XR device together with the captured observations that provide corresponding positions of the other user make it possible to determine the alignment transformation 318 needed to align the pose trajectory of one XR device with the other, and thus the two different coordinate systems. For example, the alignment transformation 318 may be a transformation that transforms the local coordinate system of the second XR device 308 to match the local coordinate system of the first XR device 304, where the local coordinate system of the first XR device 304 is used as a reference system. In some examples, each XR device runs a face detector (e.g., as part of the object tracking system 222) that tracks the face of the other user. The face detector may utilize a suitable computer vision algorithm, such as an eigen face technique. Each XR device may also run an ego-pose tracker, such as a VIO pose tracker, and the pose trackers of the XR devices may be gravity aligned. Gravitational alignment may be determined by the inertial sensor 214 (e.g., IMU). This means that one of their coordinate axes (e.g., the z-coordinate) is oriented towards the earth's center. Remaining rotational ambiguity to be estimated may thus be one-dimensional, meaning that only one angle is needed to be estimated for the orientation part of the alignment transformation. For the translation part, three values (x, y, z), thus four in total, need to be estimated. Processing may be performed at one of the XR devices or at a server, e.g., the server 112. In one type of ego-motion alignment, each XR device may run the face detector and track a fixed point on a symmetry plane of the face of the other user, and its (x, y) coordinates in each captured image or frame is output and processed. In this case, there may be an additional unknown, being a distance of the inertial sensor 214 to the fixed point, e.g., the distance from the nose of the second user 306 to the IMU of the second XR device 308. The (x, y) coordinates together with the shared pose data make the alignment problem solvable.

In some examples, the first XR device 304 and the second XR device 308 may scan a common marker or anchor point as part of ego-motion alignment. In such cases, both the first XR device 304 and the second XR device 308 may recognize a reference or anchor point in the real-world environment (e.g., via a camera and/or other sensor) and align their respective coordinate systems to the reference point or relative to the reference point. The reference or anchor point may define a point in a global or reference coordinate system. In some examples, where both the first XR device 304 and the second XR device 308 use a mapping system, such as a SLAM system, in the same real-world environment, they can share and align their maps to create the common or shared coordinate system.

The establishment of a shared and synchronized spatial reference system may make data sharing 316 between the first XR device 304 and the second XR device 308 more useful, e.g., by allowing the first XR device 304 to understand the pose of the second XR device 308 with reference to a reference coordinate system. However, due to drift or other errors during operation, the relative pose between the first XR device 304 and the second user 306 can become less accurate during the shared XR experience 300. Examples in the present disclosure provide for hand tracking data sharing. For example, the data sharing 316 includes not only device pose data sharing, but also the sharing of hand tracking data between the first XR device 304 and the second XR device 308.

The first XR device 304 can thus, in some examples, access hand tracking data generated by the second XR device 308 (e.g., by the hand tracker of the object tracking system 222 of the second XR device 308). Likewise, the second XR device 308 may access hand tracking data generated by the first XR device 304.

In some examples, when a hand is detected by the first XR device 304 during the shared XR experience 300, the hand tracker of the first XR device 304 already “knows” whether that hand belongs to another user (e.g., the second user 306) based on information shared by the second XR device 308, allowing the first XR device 304 to handle it appropriately and in a resource-effective manner. For example, the first XR device 304 can specifically track the hand of the other user using its own hand tracker while using the tracking data shared by the second XR device 308 as another source of information, or it can specifically control its operations so as not to track the hand of the other user (e.g., to perform egocentric hand tracking only), thereby conserving computing resources. Moreover, the first XR device 304 can use the shared hand tracking data to correct or compensate for errors or drift, such as drift in the estimated pose of the second XR device 308 relative to the first XR device 304, as described in greater detail elsewhere in the present disclosure.

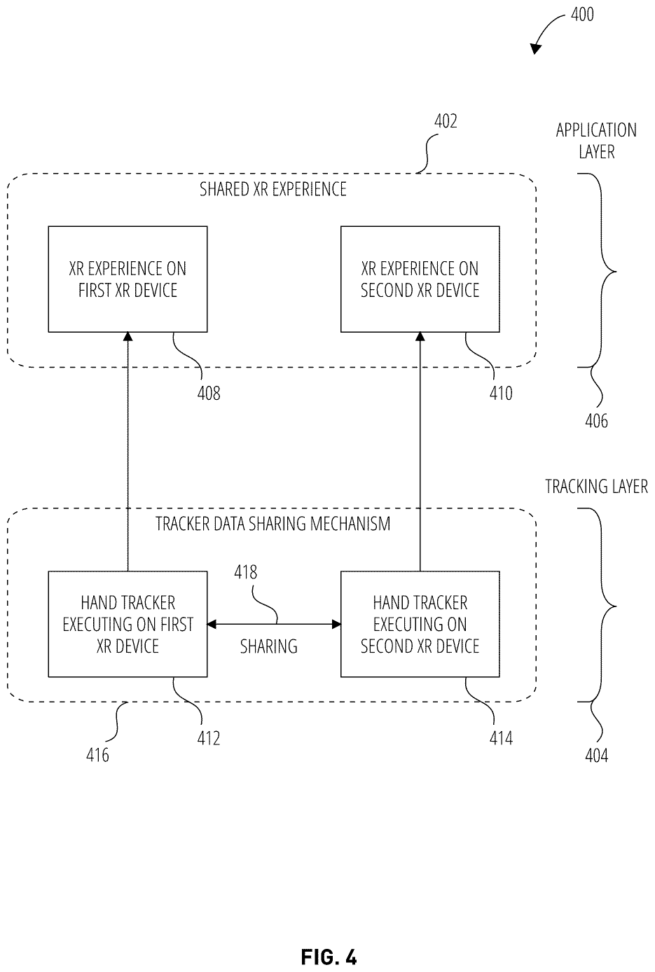

FIG. 4 diagrammatically illustrates a data sharing architecture 400 in the context of a shared XR experience 402, according to some examples. FIG. 4 shows a tracking layer 404 and an application layer 406. In some examples, the tracking layer 404 is associated with an object tracking system, such as the object tracking system 222 of the XR device 110 of FIG. 2, while the application layer 406 is associated with an application, such as the AR application 224 of the XR device 110 of FIG. 2. The tracking layer 404 and the application layer 406 operate together, but at different operating levels, to facilitate the shared XR experience 402.

The application layer 406 comprises two parallel XR experience components—an XR experience 408 executing on a first XR device (e.g., the first XR device 304) and an XR experience 410 executing on a second XR device (e.g., the second XR device 308). These experiences operate simultaneously to provide synchronized virtual content to both users, thereby providing the shared XR experience 402 for multiple users to participate in.

The tracking layer 404 implements hand tracking functionality through a hand tracker 412 executing on the first XR device and a hand tracker 414 executing on the second XR device. These hand trackers communicate directly with each other through a data sharing connection 418, enabling real-time exchange of hand tracking information at the tracker level, and thereby providing a tracker data sharing mechanism 416 for the shared XR experience 402.

The data sharing connection 418 facilitates bidirectional communication between the hand trackers, allowing each XR device to share information such as hand pose data, hand landmark data, hand motion data, and/or hand identification information. This direct tracker-to-tracker communication enables efficient hand tracking coordination between XR devices (e.g., without requiring application-level mediation).

In some examples, providing for hand tracking data sharing at the tracking layer level results in technical benefits, such as enabling early filtering of hands before they reach the tracking stage, which reduces processing and power consumption. For example, the tracking layer communication allows XR devices to identify and exclude hands belonging to other users before initiating full hand tracking operations (e.g., perform detection only, but not full hand tracking, thereby only identifying a hand but not tracking its landmarks). In some examples, this provides a specific technical benefit over application layer data sharing because the latter may result in full hand tracking in the tracking layer 404 (e.g., both detection and landmark tracking) before an XR device detects that it can exclude a particular hand.

Additionally, the tracking layer sharing enables devices to deliberately track other users' hands when needed for specific purposes, such as alignment correction or interaction verification. This selective tracking capability provides flexibility in how devices process hand data while maintaining efficient resource utilization.

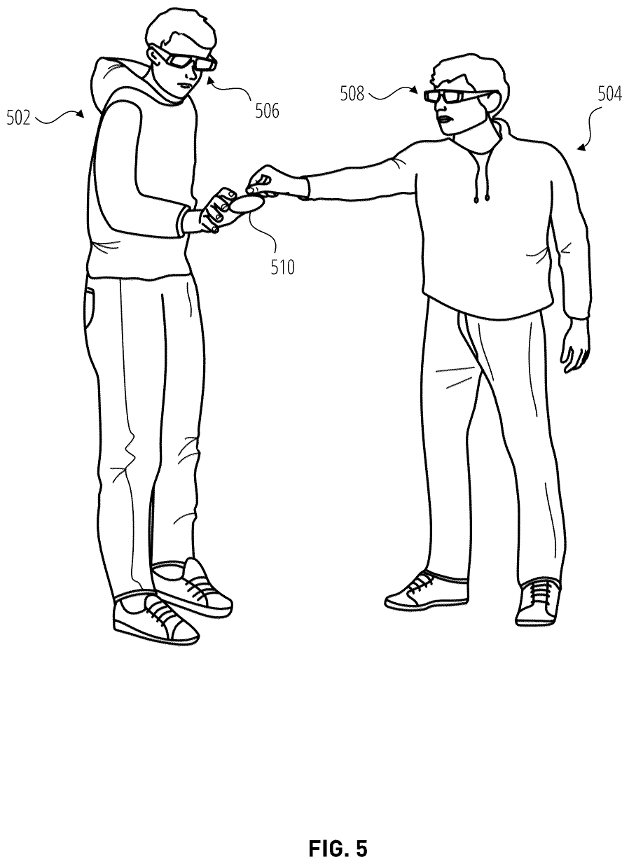

FIG. 5 illustrates a first user 502 wearing a first XR device 506 and a second user 504 wearing a second XR device 508, according to some examples. The first XR device 506 and the second XR device 508 are AR devices in the example form of AR glasses, and the AR glasses enable the first user 502 and the second user 504 to have a shared XR experience as described in the present disclosure.

The first user 502 and the second user 504 interact, via their respective devices, with virtual content in the example form of a virtual object 510. For example, the virtual object 510 is a virtual ball or a virtual planet, and the first user 502 and the second user 504 can manipulate the virtual object 510 (e.g., the second user 504 “passes” the virtual object 510 from their hand to the hand of the first user 502, as shown in FIG. 5). It is noted that while two users are shown as participating in the shared XR experience in FIG. 5, shared XR experiences can also include more than two users (e.g., three, four, or five colocated users, each wearing a suitable XR device). Examples in the present disclosure may thus also be applied to XR experiences involving more than two users.

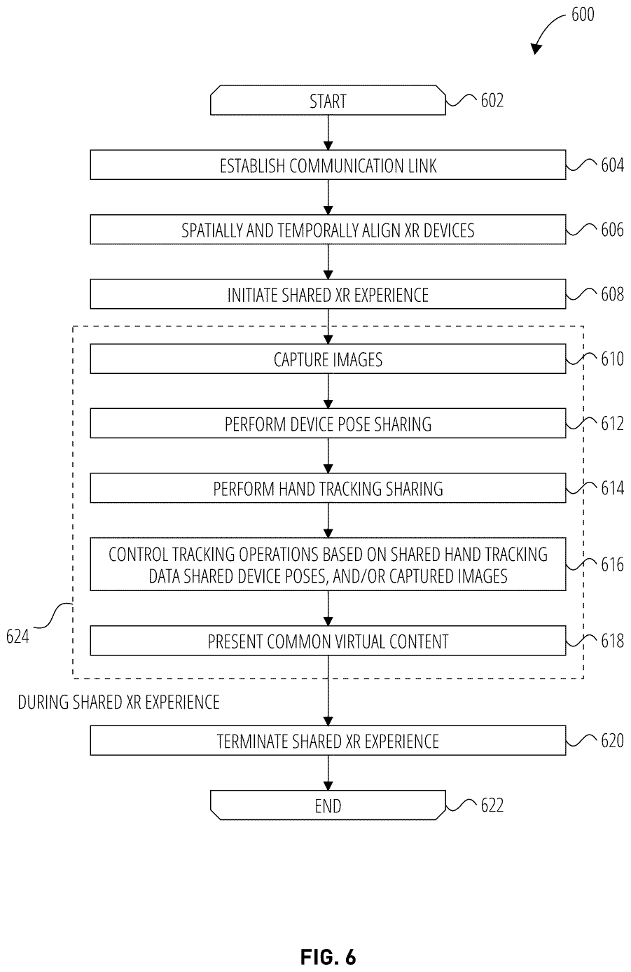

FIG. 6 illustrates a method 600 of providing a shared XR experience, according to some examples. To facilitate understanding of the method 600, the method 600 is described with reference to the example shared XR experience in which the first XR device 506 and the second XR device 508 of FIG. 5 participate. In particular, and by way of example only, operations in the method 600 are described as being performed by the first XR device 506 of the first user 502. It will be appreciated that similar operations may be performed substantially simultaneously by the second XR device 508 since data may be shared in a bidirectional manner. The first XR device 506 and/or the second XR device 508 may include one or more components similar to those of the XR device 110 as described with reference to FIG. 1 and FIG. 2. Accordingly, to describe certain aspects, reference is made below to components of the XR device 110.

The method 600 commences at opening loop operation 602 and proceeds to operation 604, where the first XR device 506 establishes a communication link with the second XR device 508 (e.g., using the communication system 210). For example, the first XR device 506 pairs wirelessly with the second XR device 508 for a particular session. This allows the first XR device 506 and the second XR device 508 to share data with each other. Such data may include device pose data and hand tracking data.

At operation 606, the first XR device 506 and the second XR device 508 perform spatial and temporal alignment (e.g., using the shared experience system 226, and as described with reference to FIG. 3). For example, the two devices establish a shared coordinate system for alignment of common virtual content to be simultaneously presented by the first XR device 506 and the second XR device 508. The shared coordinate system can be a global reference system used by both devices, that differs from their local coordinate systems. Alternatively, the shared coordinate system can be that of one of the XR devices, with positional data from the other XR device being transformed as described elsewhere herein. In other words, the devices may be localized against each other or relative to a common global map.

Once aligned and synchronized, the first XR device 506 initiates the shared XR experience at operation 608. As illustrated by block 624 in FIG. 6, various operations are performed by the first XR device 506 while the shared XR experience is in progress. These operations (operation 610 to operation 618) are discussed below, according to some examples. It will be appreciated that these operations do not necessarily occur in the sequence shown in FIG. 6—they may be performed at least partially concurrently, and may also be repeated while the shared XR experience is in progress.

At operation 610, the first XR device 506 captures images (e.g., using the image sensor 212). At least some of the images may depict both a hand (or both hands) of the first user 502 and a hand (or multiple hands) of the second user 504. Furthermore, at operation 612, the first XR device 506 participates in device pose sharing. In this way, the first XR device 506 receives the pose of the second XR device 508 and the first XR device 506 receives the pose of the second XR device 508 over the communication link.

At operation 614, the first XR device 506 participates in hand tracking sharing. In this way, the first XR device 506 receives hand tracking data from a hand tracker of the second XR device 508 and the second XR device 508 receives hand tracking data from the first XR device 506. In some examples, each device shares its egocentric hand tracking data with the other device. For example, the first XR device 506 tracks a hand of the first user 502 and shares the generated hand tracking data with the second XR device 508, while the second XR device 508 tracks a hand of the second user 504 and shares the generated hand tracking data with the first XR device 506.

At operation 616, the first XR device 506 then controls one or more of its own tracking operations based on one, more, or all of the shared hand tracking data, the shared device poses, and the captured images. In particular, the shared hand tracking data can be used in various ways to control the tracking operations of the first XR device 506. Examples are described below.

### Using Shared Hand Tracking Data to Identify a Hand and Trigger an Action

In some examples, the first XR device 506 detects the presence of a hand of the second user 504 in at least one of the images it has captured, and uses the hand tracking data shared by the second XR device 508 to identify that the hand belongs to the second user. For example, when the first XR device 506 detects a hand in its field of view via its image sensors, it receives hand tracking data from the second XR device 508 that includes identification metadata such as a user identifier or device identifier to enable proper hand attribution. For basic identification scenarios, the second XR device 508 may share simplified hand representations through the communication system 210, such as spatial boundary information (e.g., a bounding box or mask) or identification flags. For more complex scenarios, the second XR device 508 may share more detailed information such as hand landmarks. In some cases, both the simplified and more detailed information are shared.

Thus, the method 600 may include receiving an identifier associated with the hand of the second user 504 from the second XR device 508 and/or an indication of its position in the real world according to the second XR device 508, detecting the hand in the image data captured by the first XR device 506, and then using the shared hand tracking data from the second XR device 508 to identify or confirm the identity associated with the hand.

In some examples, the first XR device 506 processes the identification data by detecting potential hand regions in captured images, comparing them against received spatial data, and verifying hand ownership using the shared metadata. This enables early filtering before initiating full tracking operations. In other words, the first XR device 506 is enabled to control its tracking operations so as to dynamically exclude the hand of the second user 504 from tracking (or from further tracking). For example, the first XR device 506 filters out identified hands before initiating full skeletal tracking, skips detection processing within verified hand regions, or maintains an active list of hands to exclude based on the shared identification information. This reduces computational overhead during multi-user interactions.

In other examples, the first XR device 506 is configured to specifically track the hand of the second user 504 (e.g., because the second user 504 is participating in the shared XR experience and virtual content is to be positioned relative to the hand of the second user 504). In such cases, the first XR device 506 may initiate full skeletal tracking on positively identified hands. For example, the first XR device 506 identifies the hand as belonging to the second user 504, and then uses its own hand tracker to track the joints of the hand while maintaining proper user attribution. In some examples, the first XR device 506 can implement a selective tracking architecture in which a hand is tracked or excluded based on context or predefined rules.

Examples described herein can also enable the first XR device 506 to filter out hands of additional persons in captured images, who are not part of the shared XR experience. For example, the first XR device 506 receives tracking information (e.g., a bounding box) for the hand of the second user 504 from the second XR device 508 and thus is aware of its location. Then, upon detecting one or more other hands in the image data captured by the first XR device 506, the first XR device 506 can automatically filter out such hands to conserve computing resources and avoid conflicts or tracking errors, since such other hands are irrelevant for purposes of the shared XR experience.

It is noted that, even in scenarios where the first XR device 506 excludes the hand of the second user 504 from its own hand tracker's operations, it can still further use the shared hand tracking data for that hand, as generated by the hand tracker of the second user 504. For example, the first XR device 506 only uses its own hand tracker for egocentric hand tracking, and then estimates the pose of the hand of the second user 504 using the shared data and a suitable alignment transformation based on relative device pose. In this way, the first XR device 506 is provided with useful pose information (e.g., for the positioning of virtual content) without having to expend significant further computing resources in running its own hand tracker for hands that do not belong to the first user 502.

### Using Shared Hand Tracking Data to Address or Compensate for Pose Drift

In some examples, the first XR device 506 uses its own hand tracker to generate hand tracking data for the hand of the second user 504, and also accesses the hand tracking data received from the second XR device 508 for the same hand. The first XR device 506 then uses this information to adjust an estimated pose of the second XR device 508 relative to the first XR device 506.

For example, the first XR device 506 receives hand tracking data with 3D coordinates of each tracked joint in the local coordinate system of the second XR device 508, as generated by the hand tracker of the second XR device 508. The first XR device 506 may perform coordinate transformations to map the received hand tracking data into the local reference frame of the first XR device 506.

To detect pose drift, the first XR device 506 compares the remote hand tracking data with its own locally tracked hand data for the same hand. When a hand is visible to both devices, the first XR device 506 can calculate misalignment between the hand position reported by the remote device (transformed to local coordinates) and the hand position detected by local tracking. For example, the difference between these positions and/or orientations represents the accumulated pose drift between the devices.

The first XR device 506 can then compute a correction transform that minimizes this misalignment. This correction can be applied by the first XR device 506 immediately for rapid corrections, gradually over multiple frames to avoid visible jumps, or weighted based on tracking confidence metrics, for example. In some examples, each XR device calculates and maintains its own separate drift corrections, allowing each device to optimize its local view independently. This may enable more consistent virtual object placement relative to hands even if global alignment between devices drifts over time. The correction process may run continuously during the shared experience, providing ongoing drift compensation as users interact. The drift correction can operate on simplified hand representations (e.g., centroid positions) for efficiency, or use more detailed data (e.g., full joint position data) for greater precision.

Using Shared Hand Tracking Data Together with XR Device's Own Hand Tracker's Data to Determine or Estimate Hand Pose

As mentioned, in some examples, the first XR device 506 uses its own hand tracker to generate hand tracking data for the hand of the second user 504, and also accesses the hand tracking data received from the second XR device 508 for the same hand. The first XR device 506 can use these two sets of hand tracking data, originating from different sources, to determine or adjust an estimated pose of the relevant hand.

For example, when the hand is detected in the field of view, the first XR device 506 processes image data to generate local hand tracking data with its own hand tracker. Simultaneously, the first XR device 506 receives remote hand tracking data from the second XR device 508, describing the same hand (which is being egocentrically tracked by the second XR device 508 with its respective hand tracker). The first XR device 506 may perform coordinate transformations to map the received hand tracking data into the local reference frame of the first XR device 506.

In some examples, the first XR device 506 then implements a fusion algorithm that combines the local tracking data generated by its own hand tracker, the remote hand tracking data received from the second XR device 508, and device pose information that describes the spatial relationship between the devices. In some examples, the fusion process may apply weights to each data source, e.g., based on tracking confidence, quality, or relative positioning. For example, when a hand is clearly visible to both devices, the first XR device 506 can combine joint positions from both trackers to generate a more accurate composite pose. The first XR device 506 may continuously update these pose estimates as new tracking data becomes available from both local and remote sources.

Referring again to FIG. 6, while controlling the tracking operations in the manner described, the first XR device 506 presents virtual content to the first user 502 at operation 618. The virtual content can be positioned and/or oriented based on adjustments made using the shared hand tracking data, e.g., based on an adjusted relative device pose or based on an adjusted pose estimation for one of the hands in the field of view. The virtual content is common virtual content because it is simultaneously presented to the second user 504 by the second XR device 508.

At operation 620, the first XR device 506 terminates the shared XR experience. For example, the first user 502 provides a control instruction to end the shared XR experience, or the shared XR experience reaches its predetermined conclusion (e.g., the end of a shared game). Termination of the shared XR experience may include causing the first XR device 506 to disconnect from the second XR device 508 such that the data sharing (e.g., sharing of device poses and hand tracking data) ceases. The method 600 concludes at closing loop operation 622.

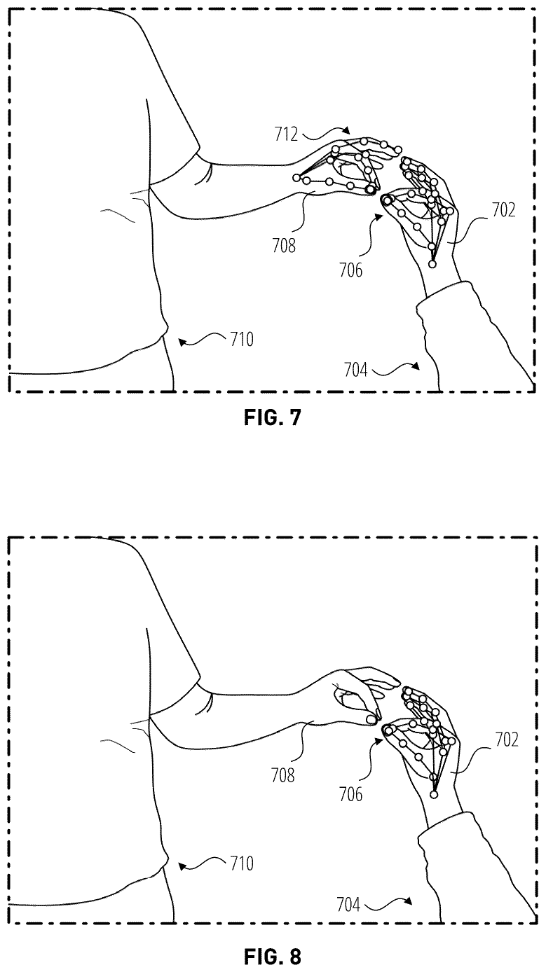

FIG. 7 to FIG. 12 illustrate aspects of the sharing of hand tracking data between two XR devices to facilitate a shared XR experience, according to some examples. Referring firstly to FIG. 7, a first hand 702 of a first user 704 is shown, together with hand tracking data for the first hand 702, in the example form of tracked landmarks 706. Furthermore, FIG. 7 shows a second hand 708 of a second user 710, together with hand tracking data for the second hand 708, in the example form of tracked landmarks 712.

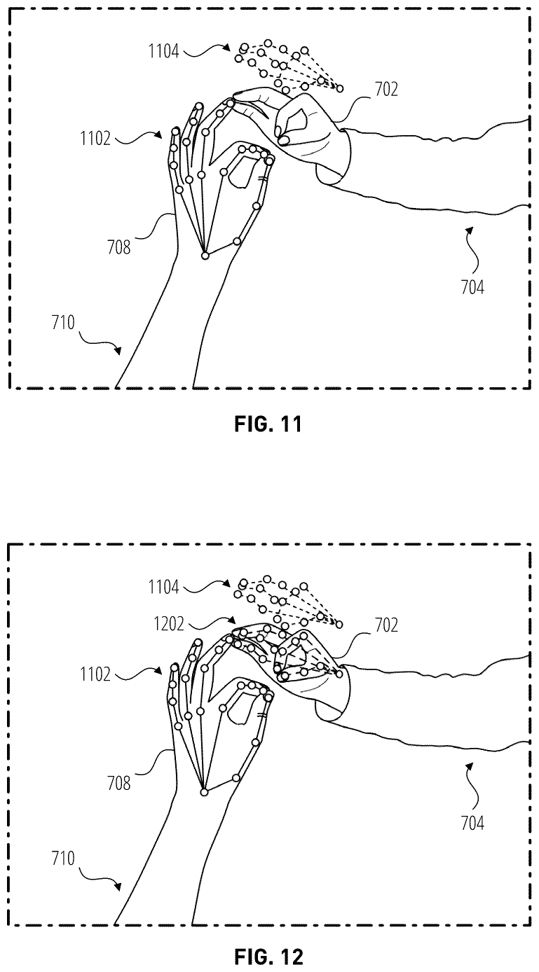

The first user 704 wears a first head-wearable XR device (not shown), such as AR glasses, and the second user 710 wears a second head-wearable XR device (not shown), such as AR glasses. FIG. 7 to FIG. 10 are shown from the perspective of first user 704, while FIG. 11 and FIG. 12 are shown form the perspective of the second user 710.

The hand landmarks in FIG. 7 to FIG. 12 are conceptually illustrated by interconnected points that indicate the skeletal structure and key features (e.g., joints) of the hand. It is noted that various other types of hand tracking data can be used in other examples, as described elsewhere herein, and hand tracking data is thus not limited to landmarks as shown in FIG. 7. It is further noted that a user would not typically be presented with tracked landmarks such as the tracked landmarks 706, 712 via a display of their XR device, but would instead be presented with virtual content that is positioned based on the tracked landmarks. The landmarks in FIG. 7 to FIG. 12 are thus primarily shown to illustrate certain aspects of the present disclosure and not to illustrate a typical end-user experience.

Initially, and prior to the state shown in FIG. 7, the XR device of the first user 704 tracks the first hand 702. In other words, the XR device performs egocentric hand tracking and generates the tracked landmarks 706. The tracked landmarks 706 are generated, for example, based on images captured by image sensors (e.g., one or more cameras) of the XR device of the second user 710. For example, the XR device executes a hand tracker that runs one or multiple hand tracking machine learning models for detection and tracking of hand landmarks. The tracked landmarks 706 obtained in this manner reflect the pose of the first hand 702, and are typically dynamically adjusted as the first hand 702 moves relative to the XR device.

Then, while the shared XR experience is in progress, the second hand 708 moves into the field of view of the XR device of the first user 704, as shown in FIG. 7. The XR device of the first user 704 may start tracking the second hand 708 and generate the tracked landmarks 712. Examples described herein enable the XR device of the first user 704 to exclude the second hand 708 from its own (internal) tracking operations based on shared tracking data received from the XR device of the second user 710, as illustrated in FIG. 8.

For example, the XR device of the first user 704 receives, from the XR device of the second user 710, bounding box data together with an identifier of the second hand 708 or the second user 710. This allows the XR device of the first user 704 to identify that the second hand 708 that it detects in its field of view belongs to the second user 710, and automatically exclude it from tracking.

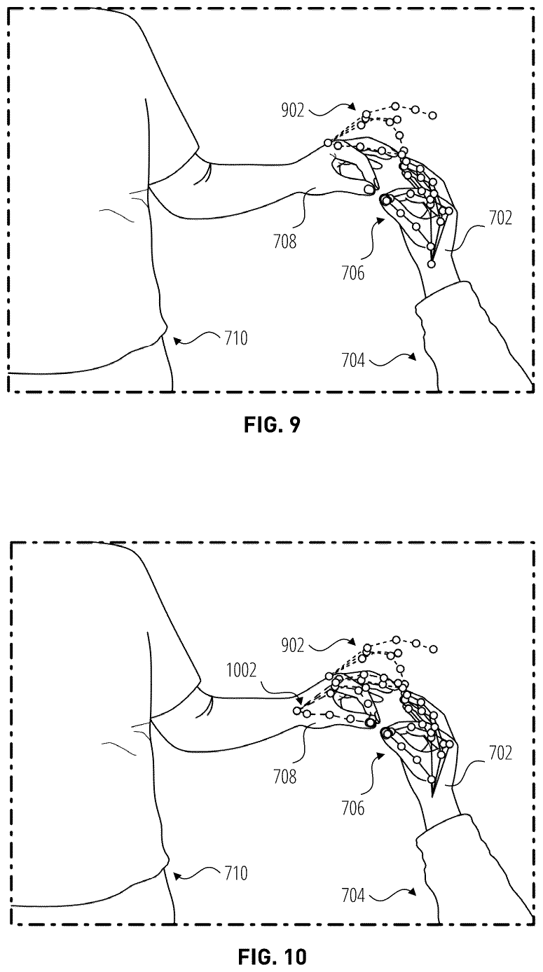

In some examples, and as shown in FIG. 9, tracked landmarks 902 as received from the XR device of the second user 710 are misaligned relative to the second hand 708 from the perspective of the first user 704. This may result from pose drift, as described elsewhere in the present disclosure, which may in turn lead to virtual content being placed incorrectly. For example, if the XR device of the first user 704 accepts and uses the tracked landmarks 902 received from the XR device of the second user 710 as shown in FIG. 9, it may incorrectly present the virtual content to the first user 704 as appearing above the second hand 708 instead of to the right of the second hand 708, or overlaid onto part of the second hand 708.

The XR device of the first user 704 can operate to correct or compensate for this misalignment and to generate adjusted landmarks 1002, as shown in FIG. 10. For example, the XR device may deliberately track the second hand 708 and/or perform pose drift correction, thereby ensuring that, from the perspective of the first user 704, virtual content is better aligned with the real world (e.g., relative to the second hand 708) as it is perceived via the XR device of the first user 704.

In some examples, the shared hand tracking data is used to calibrate the relative pose between XR devices. When a hand is visible to both devices, an XR device can compare the hand position detected by local tracking against the remote hand tracking data to calculate misalignment. This misalignment may represent accumulated pose drift between the devices that can be corrected through relative pose adjustments. The XR devices can use this hand-based calibration to refine and maintain accurate spatial alignment between the devices over time, even as device trackers (e.g., SLAM or VIO trackers) drift.

As an example, the shared XR experience may involve the first user 704 handing a virtual object to the second user 710. By improving the accuracy of the tracked hand poses, the XR device of the first user 704 can better estimate the spatial relationship between the two users, and ensure that the virtual object is presented in a more realistic manner (e.g., accurately shown between the pointed fingertips of the respective hands). In some examples, the XR device of the first user 704 dynamically realigns or adjusts virtual content on a device display (e.g., the display 232) based on shared hand tracking data and computations performed using the shared hand tracking data.

Referring now to FIG. 11, which is shown from the perspective of the second user 710, initially, the XR device of the second user 710 tracks the second hand 708. In other words, the XR device performs egocentric hand tracking and generates tracked landmarks 1102. For example, and as explained elsewhere, the XR device processes image data from one or more image sensors to detect and track the tracked landmarks 1102. The tracked landmarks 1102 are adjusted as the second hand 708 moves relative to the XR device.

While the shared XR experience is in progress, the XR device of the second user 710 receives hand tracking data in the form of unadjusted landmarks 1104 from the XR device of the first user 704. The unadjusted landmarks 1104 represent the first hand 702 as tracked from the perspective of the XR device of the first user 704. As shown in FIG. 11, and for reasons such as those explained above, the unadjusted landmarks 1104 are misaligned with the actual first hand 702, as it is perceived by the second user 710.

The XR device of the second user 710 can identify the first hand 702 as belonging to the first user 704, based on the information shared by the other XR device, and generate adjusted landmarks 1202 for the first hand 702, as shown in FIG. 12. The adjusted landmarks 1202 can be generated, for example, by using its own hand tracker to track the first hand 702, correcting for pose drift, and/or using combinations of the hand tracking data received from the other XR device and its own hand tracking data.

In some examples, to track the first hand 702 of the first user 704, the XR device of the second user 710 primarily uses the hand tracking data received from the XR device of the first user 704 for tracking, but periodically uses its own hand tracker to check for discrepancies between its own tracking data (generated based on its own captured images, from the perspective of the second user 710) and that received from the other XR device (generated based on images captured by the other XR device, from the perspective of the first user 704), and performs drift corrections or adjustments with respect to the relative XR device pose.

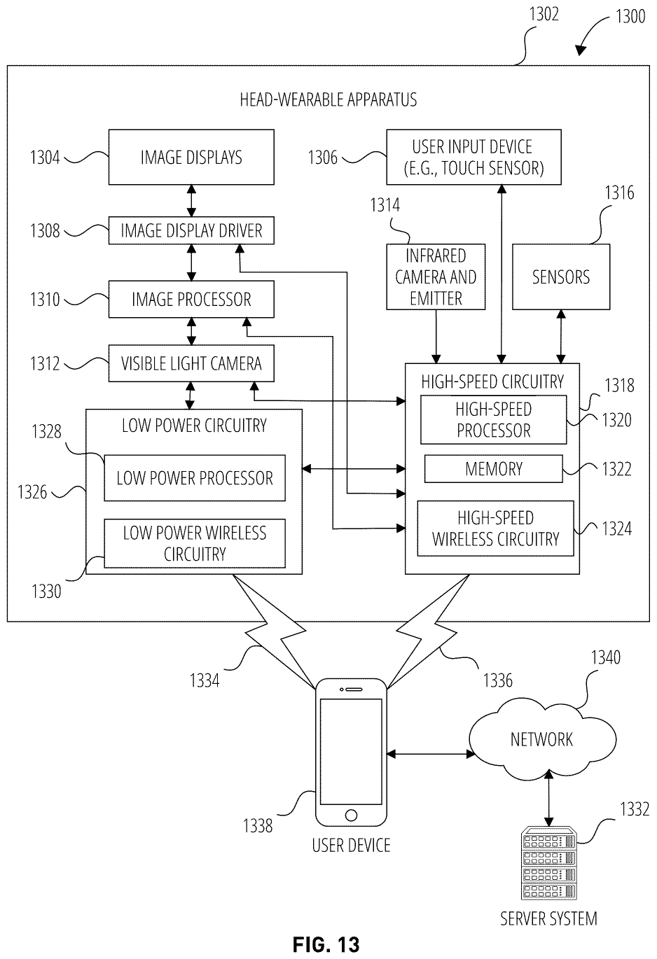

FIG. 13 illustrates a network environment 1300 in which a head-wearable apparatus 1302, such as a head-wearable XR device, can be implemented according to some examples. FIG. 13 provides a high-level functional block diagram of an example head-wearable apparatus 1302 communicatively coupled to a mobile user device 1338 and a server system 1332 via a suitable network 1340. One or more of the techniques described herein may be performed using the head-wearable apparatus 1302 or a network of devices similar to those shown in FIG. 13.

The head-wearable apparatus 1302 includes a camera, such as at least one of a visible light camera 1312 and an infrared camera and emitter 1314. The head-wearable apparatus 1302 includes other sensors 1316, such as motion sensors or eye tracking sensors. The user device 1338 can be capable of connecting with head-wearable apparatus 1302 using both a communication link 1334 and a communication link 1336. The user device 1338 is connected to the server system 1332 via the network 1340. The network 1340 may include any combination of wired and wireless connections.

The head-wearable apparatus 1302 includes a display arrangement that has several components. In this example, the arrangement includes two image displays 1304 of an optical assembly. The two displays include one associated with the left lateral side and one associated with the right lateral side of the head-wearable apparatus 1302. The head-wearable apparatus 1302 also includes an image display driver 1308, an image processor 1310, low power circuitry 1326, and high-speed circuitry 1318. The image displays 1304 are for presenting images and videos, including an image that can provide a graphical user interface to a user of the head-wearable apparatus 1302.

The image display driver 1308 commands and controls the image display of each of the image displays 1304. The image display driver 1308 may deliver image data directly to each image display of the image displays 1304 for presentation or may have to convert the image data into a signal or data format suitable for delivery to each image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (Exif) or the like.

The head-wearable apparatus 1302 may include a frame and stems (or temples) extending from a lateral side of the frame, or another component to facilitate wearing of the head-wearable apparatus 1302 by a user. The head-wearable apparatus 1302 of FIG. 13 further includes a user input device 1306 (e.g., touch sensor or push button) including an input surface on the head-wearable apparatus 1302. The user input device 1306 is configured to receive, from the user, an input selection to manipulate the graphical user interface of the presented image.

The components shown in FIG. 13 for the head-wearable apparatus 1302 are located on one or more circuit boards, for example a printed circuit board (PCB) or flexible PCB, in the rims or temples. Alternatively, or additionally, the depicted components can be located in the chunks, frames, hinges, or bridges of the head-wearable apparatus 1302. Left and right sides of the head-wearable apparatus 1302 can each include a digital camera element such as a complementary metal-oxide-semiconductor (CMOS) image sensor, charge coupled device, a camera lens, or any other respective visible or light capturing elements that may be used to capture data, including images of scenes with unknown objects.

The head-wearable apparatus 1302 includes a memory 1322 which stores instructions to perform a subset, or all, of the functions described herein. The memory 1322 can also include a storage device. As further shown in FIG. 13, the high-speed circuitry 1318 includes a high-speed processor 1320, the memory 1322, and high-speed wireless circuitry 1324. In FIG. 13, the image display driver 1308 is coupled to the high-speed circuitry 1318 and operated by the high-speed processor 1320 to drive the left and right image displays of the image displays 1304. The high-speed processor 1320 may be any processor capable of managing high-speed communications and operation of any general computing system needed for the head-wearable apparatus 1302. The high-speed processor 1320 includes processing resources needed for managing high-speed data transfers over the communication link 1336 to a wireless local area network (WLAN) using high-speed wireless circuitry 1324. In certain examples, the high-speed processor 1320 executes an operating system such as a LINUX operating system or other such operating system of the head-wearable apparatus 1302 and the operating system is stored in memory 1322 for execution. In addition to any other responsibilities, the high-speed processor 1320 executing a software architecture for the head-wearable apparatus 1302 is used to manage data transfers with high-speed wireless circuitry 1324. In certain examples, high-speed wireless circuitry 1324 is configured to implement Institute of Electrical and Electronic Engineers (IEEE) 1302.11 communication standards, also referred to herein as Wi-Fi™. In other examples, other high-speed communications standards may be implemented by high-speed wireless circuitry 1324.

The low power wireless circuitry 1330 and the high-speed wireless circuitry 1324 of the head-wearable apparatus 1302 can include short range transceivers (Bluetooth™, Bluetooth LE, Zigbee, or ANT+) and wireless wide, local, or wide area network transceivers (e.g., cellular or Wi-Fi™). The user device 1338, including the transceivers communicating via the communication link 1334 and communication link 1336, may be implemented using details of the architecture of the head-wearable apparatus 1302, as can other elements of the network 1340.

The memory 1322 includes a storage device capable of storing various data and applications, including, among other things, camera data generated by the visible light camera 1312, sensors 1316, and the image processor 1310, as well as images generated for display by the image display driver 1308 on the image displays of the image displays 1304. While the memory 1322 is shown as integrated with the high-speed circuitry 1318, in other examples, the memory 1322 may be an independent standalone element of the head-wearable apparatus 1302. In certain such examples, electrical routing lines may provide a connection through a chip that includes the high-speed processor 1320 from the image processor 1310 or low power processor 1328 to the memory 1322. In other examples, the high-speed processor 1320 may manage addressing of memory 1322 such that the low power processor 1328 will boot the high-speed processor 1320 any time that a read or write operation involving memory 1322 is needed.

As shown in FIG. 13, the low power processor 1328 or high-speed processor 1320 of the head-wearable apparatus 1302 can be coupled to the camera (visible light camera 1312, or infrared camera and emitter 1314), the image display driver 1308, the user input device 1306 (e.g., touch sensor or push button), and the memory 1322. The head-wearable apparatus 1302 also includes sensors 1316, which may be the motion components 1534, position components 1538, environmental components 1536, and biometric components 1532, e.g., as described below with reference to FIG. 15. In particular, motion components 1534 and position components 1538 are used by the head-wearable apparatus 1302 to determine and keep track of the position and orientation (the “pose”) of the head-wearable apparatus 1302 relative to a frame of reference or another object, in conjunction with a video feed from one of the visible light cameras 1312, using for example techniques such as structure from motion (SfM) or VIO.

In some examples, and as shown in FIG. 13, the head-wearable apparatus 1302 is connected with a host computer. For example, the head-wearable apparatus 1302 is paired with the user device 1338 via the communication link 1336 or connected to the server system 1332 via the network 1340. The server system 1332 may be one or more computing devices as part of a service or network computing system, for example, that include a processor, a memory, and network communication interface to communicate over the network 1340 with the user device 1338 and head-wearable apparatus 1302.

The user device 1338 includes a processor and a network communication interface coupled to the processor. The network communication interface allows for communication over the network 1340, communication link 1334 or communication link 1336. The user device 1338 can further store at least portions of the instructions for implementing functionality described herein.

Output components of the head-wearable apparatus 1302 include visual components, such as a display (e.g., one or more liquid-crystal display (LCD)), one or more plasma display panel (PDP), one or more light emitting diode (LED) display, one or more projector, or one or more waveguide. The image displays 1304 of the optical assembly are driven by the image display driver 1308. The output components of the head-wearable apparatus 1302 further include acoustic components (e.g., speakers), haptic components (e.g., a vibratory motor), other signal generators, and so forth. The input components of the head-wearable apparatus 1302, the user device 1338, and server system 1332, such as the user input device 1306, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 1302 may optionally include additional peripheral device elements. Such peripheral device elements may include sensors or display elements integrated with the head-wearable apparatus 1302. For example, peripheral device elements may include any I/O components including output components, motion components, position components, or any other such elements described herein.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi™ or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over a communication link 1336 from the user device 1338 via the low power wireless circuitry 1330 or high-speed wireless circuitry 1324.

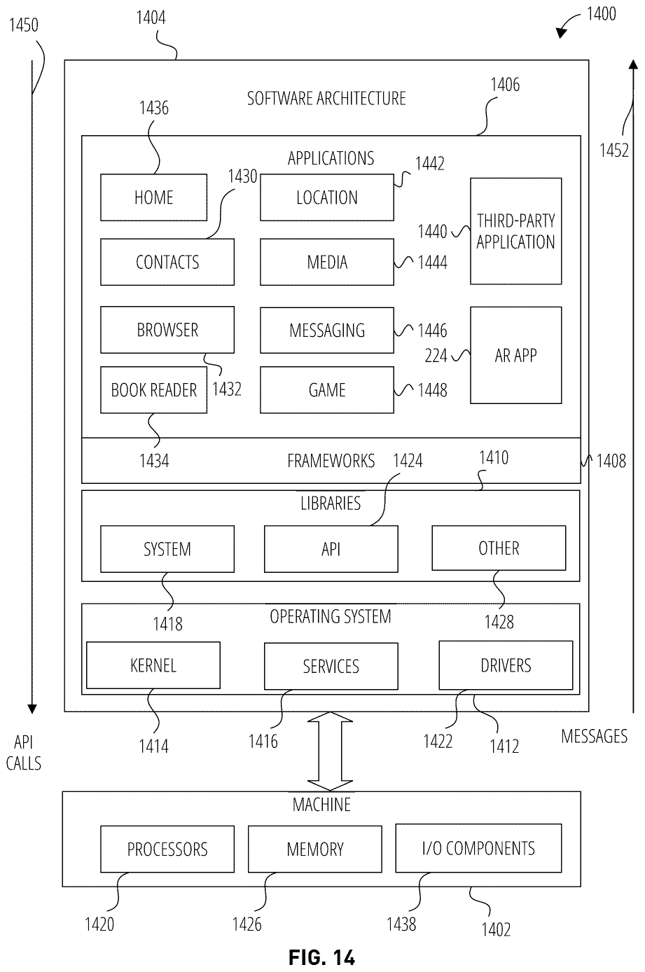

FIG. 14 is a block diagram 1400 illustrating a software architecture 1404, which can be installed on any one or more of the devices described herein. The software architecture 1404 is supported by hardware such as a machine 1402 that includes processors 1420, memory 1426, and I/O components 1438. In this example, the software architecture 1404 can be conceptualized as a stack of layers, where each layer provides a particular functionality. The software architecture 1404 includes layers such as an operating system 1412, libraries 1410, frameworks 1408, and applications 1406. Operationally, the applications 1406 invoke Application Programming Interface calls, API calls 1450, through the software stack and receive messages 1452 in response to the API calls 1450.

The operating system 1412 manages hardware resources and provides common services. The operating system 1412 includes, for example, a kernel 1414, services 1416, and drivers 1422. The kernel 1414 acts as an abstraction layer between the hardware and the other software layers. For example, the kernel 1414 provides memory management, processor management (e.g., scheduling), component management, networking, and security settings, among other functionality. The services 1416 can provide other common services for the other software layers. The drivers 1422 are responsible for controlling or interfacing with the underlying hardware. For instance, the drivers 1422 can include display drivers, camera drivers, Bluetooth™ or Bluetooth™ Low Energy drivers, flash memory drivers, serial communication drivers (e.g., Universal Serial Bus (USB) drivers), WI-FI™ drivers, audio drivers, power management drivers, and so forth.

The libraries 1410 provide a low-level common infrastructure used by the applications 1406. The libraries 1410 can include system libraries 1418 (e.g., C standard library) that provide functions such as memory allocation functions, string manipulation functions, mathematical functions, and the like. In addition, the libraries 1410 can include API libraries 1424 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1410 can also include a wide variety of other libraries 1428 to provide many other APIs to the applications 1406.

The frameworks 1408 provide a high-level common infrastructure that is used by the applications 1406. For example, the frameworks 1408 provide various graphical user interface (GUI) functions, high-level resource management, and high-level location services. The frameworks 1408 can provide a broad spectrum of other APIs that can be used by the applications 1406, some of which may be specific to a particular operating system or platform.

In some examples, the applications 1406 may include a home application 1436, a contacts application 1430, a browser application 1432, a book reader application 1434, a location application 1442, a media application 1444, a messaging application 1446, a game application 1448, and a broad assortment of other applications such as a third-party application 1440. The applications 1406 are programs that execute functions defined in the programs. Various programming languages can be employed to create one or more of the applications 1406, structured in a variety of manners, such as object-oriented programming languages (e.g., Objective-C, Java, or C++) or procedural programming languages (e.g., C or assembly language). In some examples, the third-party application 1440 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In FIG. 14, the third-party application 1440 can invoke the API calls 1450 provided by the operating system 1412 to facilitate functionality described herein. The applications 1406 may include an AR application such as the AR application 224 described herein, according to some examples.

FIG. 15 is a diagrammatic representation of a machine 1500 within which instructions 1508 (e.g., software, a program, an application, an applet, an app, or other executable code) for causing the machine 1500 to perform one or more of the methodologies discussed herein may be executed. For example, the instructions 1508 may cause the machine 1500 to execute any one or more of the methods described herein. The instructions 1508 transform the general, non-programmed machine 1500 into a particular machine 1500 programmed to carry out the described and illustrated functions in the manner described. The machine 1500 may operate as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a server computer, a client computer, a personal computer (PC), a tablet computer, a laptop computer, a netbook, a cellular telephone, a smart phone, a mobile device, a wearable device (e.g., a smart watch), XR device, VR device, a smart home device (e.g., a smart appliance), other smart devices, a web appliance, a network router, a network switch, a network bridge, or any machine capable of executing the instructions 1508, sequentially or otherwise, that specify actions to be taken by the machine 1500. Further, while only a single machine 1500 is illustrated, the term “machine” shall also be taken to include a collection of machines that individually or jointly execute the instructions 1508 to perform one or more of the methodologies discussed herein.

The machine 1500 may include processors 1502, memory 1504, and I/O components 1542, which may be configured to communicate with each other via a bus 1544. In some examples, the processors 1502 may include, for example, a processor 1506 and a processor 1510 that execute the instructions 1508. Although FIG. 15 shows multiple processors 1502, the machine 1500 may include a single processor with a single core, a single processor with multiple cores (e.g., a multi-core processor), multiple processors with a single core, multiple processors with multiples cores, or any combination thereof.

The memory 1504 includes a main memory 1512, a static memory 1514, and a storage unit 1516, accessible to the processors via the bus 1544. The main memory 1504, the static memory 1514, and storage unit 1516 store the instructions 1508 embodying any one or more of the methodologies or functions described herein. The instructions 1508 may also reside, completely or partially, within the main memory 1512, within the static memory 1514, within machine-readable medium 1518 within the storage unit 1516, within at least one of the processors, or any suitable combination thereof, during execution thereof by the machine 1500.

The I/O components 1542 may include a wide variety of components to receive input, provide output, produce output, transmit information, exchange information, capture measurements, and so on. The specific I/O components 1542 that are included in a particular machine will depend on the type of machine. For example, portable machines such as mobile phones may include a touch input device or other such input mechanisms, while a headless server machine will likely not include such a touch input device. It will be appreciated that the I/O components 1542 may include many other components that are not shown in FIG. 15. In various examples, the I/O components 1542 may include output components 1528 and input components 1530. The output components 1528 may include visual components (e.g., a display such as a plasma display panel (PDP), a light emitting diode (LED) display, a LCD, a projector, or a cathode ray tube (CRT)), acoustic components (e.g., speakers), haptic components (e.g., a vibratory motor, resistance mechanisms), other signal generators, and so forth. The input components 1530 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In some examples, the I/O components 1542 may include biometric components 1532, motion components 1534, environmental components 1536, or position components 1538, among a wide array of other components. For example, the biometric components 1532 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1534 include acceleration sensor components (e.g., accelerometer), gravitation sensor components, rotation sensor components (e.g., gyroscope), and so forth. The environmental components 1536 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1538 include location sensor components (e.g., a GPS receiver components), altitude sensor components (e.g., altimeters or barometers that detect air pressure from which altitude may be derived), orientation sensor components (e.g., magnetometers), and the like.

Communication may be implemented using a wide variety of technologies. The I/O components 1542 further include communication components 1540 operable to couple the machine 1500 to a network 1520 or devices 1522 via a coupling 1524 and a coupling 1526, respectively. For example, the communication components 1540 may include a network interface component or another suitable device to interface with the network 1520. In further examples, the communication components 1540 may include wired communication components, wireless communication components, cellular communication components, Near Field Communication (NFC) components, Bluetooth™ components, Wi-Fi™ components, and other communication components to provide communication via other modalities. The devices 1522 may be another machine or any of a wide variety of peripheral devices (e.g., a peripheral device coupled via a USB).

Moreover, the communication components 1540 may detect identifiers or include components operable to detect identifiers. For example, the communication components 1540 may include Radio Frequency Identification (RFID) tag reader components, NFC smart tag detection components, optical reader components (e.g., an image sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1540, such as location via Internet Protocol (IP) geolocation, location via Wi-Fi™ signal triangulation, location via detecting an NFC beacon signal that may indicate a particular location, and so forth.

The various memories (e.g., memory 1504, main memory 1512, static memory 1514, and/or memory of the processors 1502) and/or storage unit 1516 may store one or more sets of instructions and data structures (e.g., software) embodying or used by any one or more of the methodologies or functions described herein. These instructions (e.g., the instructions 1508), when executed by processors 1502, cause various operations to implement the disclosed examples.

The instructions 1508 may be transmitted or received over the network 1520, using a transmission medium, via a network interface device (e.g., a network interface component included in the communication components 1540) and using any one of a number of well-known transfer protocols (e.g., hypertext transfer protocol (HTTP)). Similarly, the instructions 1508 may be transmitted or received using a transmission medium via the coupling 1526 (e.g., a peer-to-peer coupling) to the devices 1522.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks.

The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine 1500, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### CONCLUSION

Although aspects have been described with reference to specific examples, it will be evident that various modifications and changes may be made to these examples without departing from the broader scope of the present disclosure. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

As used herein, the term “processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), an FPGA, a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, Very Long Instruction Word (VLIW), vector processing, or Single Instruction, Multiple Data (SIMD) that allow each core to run separate instruction streams concurrently. A processor may be emulated in software, running on a physical processor, as a virtual processor or virtual circuit. The virtual processor may behave like an independent processor but is implemented in software rather than hardware.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

The various features, steps, operations, and processes described herein may be used independently of one another, or may be combined in various ways. All possible combinations and subcombinations are intended to fall within the scope of this disclosure. In addition, certain method or process blocks or operations may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLES

In view of the above-described implementations of subject matter this application discloses the following list of examples, wherein one feature of an example in isolation, or more than one feature of an example taken in combination, and, optionally, in combination with one or more features of one or more further examples, are further examples also falling within the disclosure of this application.

Example 1 is a method performed by a first XR device of a first user, the method comprising: establishing a communication link with a second XR device of a second user; capturing images that include, a first hand of the first user and a second hand of the second user; receiving, from the second XR device and via the communication link, hand tracking data for the second hand of the second user; and while the first XR device and the second XR device are participating in a shared XR experience, controlling tracking performed by the first XR device based on the images captured by the first XR device and the hand tracking data received from the second XR device.

In Example 2, the subject matter of Example 1 includes, wherein the first XR device is a first head-wearable device that is worn by the first user, and the second XR device is a second head-wearable device that is worn by the second user.

In Example 3, the subject matter of Examples 1-2 includes, wherein the hand tracking data received from the second XR device comprises second hand tracking data for the second hand, and the method further comprises, while the shared XR experience is in progress: transmitting, via the communication link, first hand tracking data for the first hand to the second XR device.

In Example 4, the subject matter of Examples 1-3 includes, wherein the tracking performed by the XR device comprises hand tracking, and the controlling of the hand tracking performed by the first XR device comprises: detecting presence of the second hand in at least one of the images; identifying, based at least partially on the hand tracking data received from the second XR device, that the second hand belongs to the second user; and in response to identifying that the second hand belongs to the second user, excluding the second hand from the hand tracking performed by the first XR device.

In Example 5, the subject matter of Examples 1-4 includes, wherein the controlling of the tracking performed by the first XR device comprises using the hand tracking data to adjust an estimated pose of the second XR device relative to the first XR device.

In Example 6, the subject matter of Examples 1-5 includes, wherein the tracking performed by the XR device comprises hand tracking, and the controlling of the hand tracking performed by the first XR device comprises: detecting presence of the second hand in at least one of the images; identifying, based at least partially on the hand tracking data received from the second XR device, that the second hand belongs to the second user; and in response to identifying that the second hand belongs to the second user, applying the hand tracking to both the first hand and the second hand.

In Example 7, the subject matter of Example 6 includes, wherein the tracking performed by the first XR device further comprises tracking the second XR device, and the method further comprises: generating further hand tracking data for the second hand using the hand tracking performed by the first XR device; while the shared XR experience is in progress, determining an estimated pose of the second XR device relative to the first XR device based on device pose data received from the second XR device; and using the tracking data received from the second XR device and the further hand tracking data generated by the first XR device to adjust the estimated pose of the second XR device relative to the first XR device.

In Example 8, the subject matter of Examples 6-7 includes, wherein the hand tracking performed by the first XR device comprises tracking the first hand and the second hand based on the images captured by the first XR device while providing the shared XR experience.

In Example 9, the subject matter of Examples 6-8 includes, detecting presence of a third hand in at least one of the images, the third hand belonging to a person not participating in the shared XR experience; and excluding the third hand from the hand tracking performed by the first XR device.

In Example 10, the subject matter of Examples 1-9 includes, while the shared XR experience is in progress: transmitting, to the second XR device, first device pose data that describes a pose of the first XR device; and receiving, from the second XR device, second device pose data that describes a pose of the second XR device.

In Example 11, the subject matter of Examples 1-10 includes, causing presentation, to the first user, of common virtual content within a context of the shared XR experience, wherein the second XR device simultaneously causes presentation, to the second user, of the common virtual content.

In Example 12, the subject matter of Examples 1-11 includes, wherein the tracking performed by the XR device comprises hand tracking, and the controlling of the hand tracking performed by the first XR device comprises determining a pose of the second hand based at least partially on the hand tracking data received from the second XR device, the method further comprising: using the pose of the second hand to cause presentation, to the first user, of common virtual content relative to the second hand in a context of the shared XR experience, wherein the second XR device simultaneously causes presentation, to the second user, of the common virtual content.

In Example 13, the subject matter of Example 12 includes, generating further hand tracking data for the second hand using the hand tracking performed by the first XR device, wherein the pose of the second hand is determined based on the hand tracking data received from the second XR device and the further hand tracking data generated by the first XR device.

In Example 14, the subject matter of Examples 1-13 includes, using the hand tracking data received from the second XR device to identify the second hand in at least one of the images.

In Example 15, the subject matter of Example 14 includes, mapping the hand tracking data received from the second XR device to a coordinate system used by the first XR device, wherein the mapped hand tracking data is used to identify the second hand.

In Example 16, the subject matter of Examples 1-15 includes, wherein the controlling of the tracking performed by the first XR device comprises using the hand tracking data received from the second XR device to estimate a spatial relationship between the first hand and the second hand while the shared XR experience is in progress.

In Example 17, the subject matter of Examples 1-16 includes, wherein the hand tracking data comprises at least one of: hand pose data, hand landmark data, hand motion data, an identifier of the second hand, or an identifier of the second user.

In Example 18, the subject matter of Examples 1-17 includes, establishing a shared coordinate system for alignment of common virtual content simultaneously presented by the first XR device and the second XR device, wherein the first XR device uses the hand tracking data received from the second XR device to position the common virtual content for presentation to the first user.

Example 19 is an XR device comprising: at least one processor; and at least one memory component storing instructions that, when executed by the at least one processor, configure the XR device, when used by a first user, to perform operations comprising: establishing a communication link with another XR device of a second user; capturing images that include, a first hand of the first user and a second hand of the second user; receiving, from the other XR device and via the communication link, hand tracking data for the second hand of the second user; and while the XR device and the other XR device are participating in a shared XR experience, controlling tracking performed by the XR device based on the images captured by the XR device and the hand tracking data received from the other XR device.

Example 20 is a non-transitory computer-readable storage medium, the computer-readable storage medium including instructions that when executed by at least one processor of a first XR device of a first user, cause the at least one processor to perform operations comprising: establishing a communication link with a second XR device of a second user; capturing images that include, a first hand of the first user and a second hand of the second user; receiving, from the second XR device and via the communication link, hand tracking data for the second hand of the second user; and while the first XR device and the second XR device are participating in a shared XR experience, controlling tracking performed by the first XR device based on the images captured by the first XR device and the hand tracking data received from the second XR device.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

What is claimed is:

1. A method performed by a first extended reality (XR) device of a first user, the method comprising:
establishing a communication link with a second XR device of a second user;
capturing images that include a first hand of the first user and a second hand of the second user;
receiving, from the second XR device and via the communication link, hand tracking data for the second hand of the second user; and
while the first XR device and the second XR device are participating in a shared XR experience, controlling tracking performed by the first XR device based on the images captured by the first XR device and the hand tracking data received from the second XR device.

2. The method of claim 1, wherein the first XR device is a first head-wearable device that is worn by the first user, and the second XR device is a second head-wearable device that is worn by the second user.

3. The method of claim 1, wherein the hand tracking data received from the second XR device comprises second hand tracking data for the second hand, and the method further comprises, while the shared XR experience is in progress:
transmitting, via the communication link, first hand tracking data for the first hand to the second XR device.

4. The method of claim 1, wherein the tracking performed by the XR device comprises hand tracking, and the controlling of the hand tracking performed by the first XR device comprises:
detecting presence of the second hand in at least one of the images;
identifying, based at least partially on the hand tracking data received from the second XR device, that the second hand belongs to the second user; and
in response to identifying that the second hand belongs to the second user, excluding the second hand from the hand tracking performed by the first XR device.

5. The method of claim 1, wherein the controlling of the tracking performed by the first XR device comprises using the hand tracking data to adjust an estimated pose of the second XR device relative to the first XR device.

6. The method of claim 1, wherein the tracking performed by the XR device comprises hand tracking, and the controlling of the hand tracking performed by the first XR device comprises:
detecting presence of the second hand in at least one of the images;
identifying, based at least partially on the hand tracking data received from the second XR device, that the second hand belongs to the second user; and
in response to identifying that the second hand belongs to the second user, applying the hand tracking to both the first hand and the second hand.

7. The method of claim 6, wherein the tracking performed by the first XR device further comprises tracking the second XR device, and the method further comprises:
generating further hand tracking data for the second hand using the hand tracking performed by the first XR device;
while the shared XR experience is in progress, determining an estimated pose of the second XR device relative to the first XR device based on device pose data received from the second XR device; and
using both the hand tracking data received from the second XR device and the further hand tracking data generated by the first XR device to adjust the estimated pose of the second XR device relative to the first XR device.

8. The method of claim 6, wherein the hand tracking performed by the first XR device comprises tracking the first hand and the second hand based on the images captured by the first XR device while providing the shared XR experience.

9. The method of claim 6, further comprising:
detecting presence of a third hand in at least one of the images, the third hand belonging to a person not participating in the shared XR experience; and
excluding the third hand from the hand tracking performed by the first XR device.

10. The method of claim 1, further comprising, while the shared XR experience is in progress:
transmitting, to the second XR device, first device pose data that describes a pose of the first XR device; and
receiving, from the second XR device, second device pose data that describes a pose of the second XR device.

11. The method of claim 1, further comprising:
causing presentation, to the first user, of common virtual content within a context of the shared XR experience, wherein the second XR device simultaneously causes presentation, to the second user, of the common virtual content.

12. The method of claim 1, wherein the tracking performed by the XR device comprises hand tracking, and the controlling of the hand tracking performed by the first XR device comprises determining a pose of the second hand based at least partially on the hand tracking data received from the second XR device, the method further comprising:
using the pose of the second hand to cause presentation, to the first user, of common virtual content relative to the second hand in a context of the shared XR experience, wherein the second XR device simultaneously causes presentation, to the second user, of the common virtual content.

13. The method of claim 12, comprising:
generating further hand tracking data for the second hand using the hand tracking performed by the first XR device, wherein the pose of the second hand is determined based on both the hand tracking data received from the second XR device and the further hand tracking data generated by the first XR device.

14. The method of claim 1, comprising:
using the hand tracking data received from the second XR device to identify the second hand in at least one of the images.

15. The method of claim 14, comprising:
mapping the hand tracking data received from the second XR device to a coordinate system used by the first XR device, wherein the mapped hand tracking data is used to identify the second hand.

16. The method of claim 1, wherein the controlling of the tracking performed by the first XR device comprises using the hand tracking data received from the second XR device to estimate a spatial relationship between the first hand and the second hand while the shared XR experience is in progress.

17. The method of claim 1, wherein the hand tracking data comprises at least one of: hand pose data, hand landmark data, hand motion data, an identifier of the second hand, or an identifier of the second user.

18. The method of claim 1, further comprising:
establishing a shared coordinate system for alignment of common virtual content to be simultaneously presented by the first XR device and the second XR device, wherein the first XR device uses the hand tracking data received from the second XR device to position the common virtual content for presentation to the first user.

19. An extended reality (XR) device comprising:
at least one processor; and
at least one memory component storing instructions that, when executed by the at least one processor, configure the XR device, when used by a first user, to perform operations comprising:
establishing a communication link with another XR device of a second user;
capturing images that include a first hand of the first user and a second hand of the second user;
receiving, from the other XR device and via the communication link, hand tracking data for the second hand of the second user; and
while the XR device and the other XR device are participating in a shared XR experience, controlling tracking performed by the XR device based on the images captured by the XR device and the hand tracking data received from the other XR device.

20. A non-transitory computer-readable storage medium, the computer-readable storage medium including instructions that when executed by at least one processor of a first extended reality (XR) device of a first user, cause the at least one processor to perform operations comprising:
establishing a communication link with a second XR device of a second user;
capturing images that include a first hand of the first user and a second hand of the second user;
receiving, from the second XR device and via the communication link, hand tracking data for the second hand of the second user; and
while the first XR device and the second XR device are participating in a shared XR experience, controlling tracking performed by the first XR device based on the images captured by the first XR device and the hand tracking data received from the second XR device.
